(19) United States
(12) Patent Application Publication
(10) Pub. No.: US 2013/0023642 A1
(43) Pub. Date: Jan. 24, 2013

(54) POLYESTER AMIDE COMPOUND

(71) Applicants: Takafumi Oda, Kanagawa (JP); Ryoji Otaki, Kanagawa (JP)

(72) Inventors: Takafumi Oda, Kanagawa (JP); Ryoji Otaki, Kanagawa (JP)

(73) Assignee: MITSUBISHI GAS CHEMICAL COMPANY INC, TOKYO (JP)

(21) Appl. No.: 13/638,292

(22) PCT Filed: Feb. 23, 2011
(86) PCT No.: PCT/JP11/53927

§ 371 Date: Sep. 28, 2012

(30) Foreign Application Priority Data
Apr. 1, 2010 (JP) 2010-085305

(51) Int. Cl. C08G 69/10

(52) U.S. Cl. 528/328

(57) ABSTRACT

A polyesteramide compound containing from 50 to 99.9 mol % of an ester unit represented by the following general formula (I), and from 0.1 to 50 mol % of a constituent unit represented by the following general formula (II):

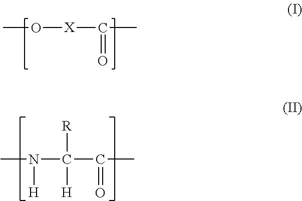

wherein, in the above-mentioned general formula (I), X represents an alkylene group; in the above-mentioned general formula (II), R represents a substituted or unsubstituted alkyl group, or a substituted or unsubstituted aryl group.

### TECHNICAL FIELD

The present invention relates to a polyesteramide compound (including polyesteramide resin and polyesteramide oligomer) capable of expressing oxygen absorption performance, and to a polyesteramide composition containing the polyesteramide compound.

### BACKGROUND ART

A polyhydroxycarboxylic acid to be obtained through ring-opening polymerization of a cyclic ester such as an intermolecular cyclic ester of two molecules of a hydroxycarboxylic acid or the like is biodegradable and is specifically noted as a polymer material gentle to the environment (so-called green plastics). As the polyhydroxycarboxylic acid, for example, there are known a polyglycolic acid (also referred to as a polyglycolide) to be obtained through ring-opening polymerization of a glycolide, or that is, an intermolecular cyclic ester of two molecules of a glycolic acid, and a polylactic acid (also referred to as a polylactides) to be obtained through ring-opening polymerization of a lactide, or that is, an intermolecular cyclic ester of two molecules of a lactic acid.

In particular, polyglycolic acid has excellent gas barrier property and mechanical strength, and development of novel applications thereof for sheets, films, containers, injection-molded articles and others has become tried (see Patent Documents 1 and 2). Nevertheless, containers and shapes of polyglycolic acid are excellent as packaging materials but have a problem in point of the storability of the contents therein since oxygen penetration through the container wall is on a non-negligible order level and, in addition, the contents inside the containers are oxidized and deteriorated owing to the remaining oxygen therein.

For preventing oxygen penetration from the outside thereof, the containers and the shapes of thermoplastic resin are so planned that the container wall could have a multilayer structure, at least one layer of which is an oxygen barrier layer of polymetaxylylenadipamide, ethylene/vinyl alcohol copolymer, polyacrylonitrile, aluminium foil or the like. However, it is still impossible to fully prevent even slight oxygen from penetrating into the containers from outside, and is also impossible to prevent the contents sensible to oxygen such as beer or the like from being deteriorated by oxygen remaining in the containers.

For removing oxygen from containers, an oxygen absorbent has been used in the past. For example, Patent Documents 3 and 4 describe an oxygen-absorbing multilayer structure and an oxygen-absorbing film with an oxygen absorbent such as iron powder or the like dispersed in resin. Patent Document 5 describes an oxygen-collecting barrier for packaging capable of absorbing oxygen inside and outside a container formed of a polymer material such as polyamide or the like with a metallic catalyst such as cobalt or the like added thereto. Patent Document 6 describes a product having an oxygen-scavenging layer that contains an ethylenic unsaturated compound such as polybutadiene or the like and a transition metal catalyst such as cobalt or the like, and an oxygen-blocking layer of polyamide or the like.

### CITATION LIST

### Patent Literature

[Patent Document 1] JP-A-10-60136
[Patent Document 2] JP-A-10-337772
[Patent Document 3] JP-A-2-72851
[Patent Document 4] JP-A-4-90848
[Patent Document 5] Japanese Patent 2991437
[Patent Document 6] JP-A-5-115776

### SUMMARY OF INVENTION

### Technical Problem

The oxygen-absorbing multilayer structure and the oxygen-absorbing film with an oxygen absorbent such as iron powder or the like dispersed in resin are nontransparent since the resin is colored with the oxygen absorbent such as iron powder or the like therein, and are therefore constrained in point of the use thereof in that they could not be used in the field of packaging that requires transparency.

On the other hand, the oxygen-trapping resin composition that contains a transition metal such as cobalt or the like is advantageous in that it is applicable also to packaging containers that require transparency, but is unfavorable since the resin composition is colored by the transition metal catalyst. In addition, in the resin composition, the resin absorbs oxygen and is thereby oxidized in the presence of the transition metal catalyst. Concretely, there would occur various reactions of radical generation to be caused by hydrogen atom drawing away from the methylene chain adjacent to the arylene group in the polyamide resin, peroxy radical generation to be caused by oxygen molecule addition to the radical, and hydrogen atom drawing to be caused by the peroxy radical. Since the resin is oxidized through oxygen absorption of the mechanism as above, there occur various problems in that a decomposed product is generated to give an unfavorable odor to the contents in the containers, and the resin is deteriorated through oxidation to thereby discolor the containers or lower the strength of the containers.

The problem to be solved by the present invention is to provide a polyesteramide compound and a polyesteramide composition capable of expressing sufficient oxygen absorption performance even though not containing a metal.

### Solution to Problems

The present invention provides a polyesteramide compound and a polyesteramide composition mentioned below.

<1> A polyesteramide compound containing from 50 to 99.9 mol % of an ester unit represented by the following general formula (I), and from 0.1 to 50 mol % of a constituent unit represented by the following general formula (II):

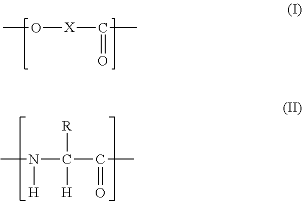

wherein, in the above-mentioned general formula (I), X represents an alkylene group; in the above-mentioned general formula (II), R represents a substituted or unsubstituted alkyl group, or a substituted or unsubstituted aryl group.
<2> A polyesteramide composition containing the polyesteramide compound of the above <1>.

### Advantageous Effects of Invention

The polyesteramide compound and the polyesteramide composition of the present invention are excellent in oxygen absorption performance. Accordingly, for example, the polyesteramide compound and the polyesteramide composition of the present invention are favorable for use as an oxygen absorbent, as capable of being filled in pouches or the like. A more preferred embodiment of using the polyesteramide compound and the polyesteramide composition of the present invention is using them in packaging materials and packaging containers. The packaging materials and packaging containers using the polyesteramide compound or the polyesteramide composition of the present invention can express sufficient oxygen absorption performance even though not containing a metal, do not generate any offensive odor, can have an extremely good transparency and can store the contents therein in a good condition.

### BRIEF DESCRIPTION OF DRAWINGS

FIG. 1 This is a ¹H-NMR chart of the polyesteramide compound 1 produced in Example 1.

### DESCRIPTION OF EMBODIMENTS

### 1. Polyesteramide Compound

The polyesteramide compound of the present invention contains from 50 to 99.9 mol % of an ester unit represented by the following general formula (I), and from 0.1 to 50 mol % of a tertiary hydrogen-containing carboxylic acid unit (preferably a constituent unit represented by the following general formula (II)):

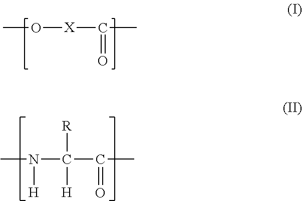

wherein, in the above-mentioned general formula (I), X represents an alkylene group; in the above-mentioned general formula (II), R represents a substituted or unsubstituted alkyl group, or a substituted or unsubstituted aryl group.

However, the total of the ester unit and the tertiary hydrogen-containing carboxylic acid unit should not exceed 100 mol %. The polyesteramide compound of the present invention may contain any other constituent unit than those mentioned above, within a range not detracting from the advantage of the present invention.

The polyesteramide compound of the present invention includes a polyesteramide resin and a polyesteramide oligomer.

The “polyesteramide resin” of the present invention means a polymer having a limiting viscosity of at least 0.4 dl/g of the polyesteramide compound of the present invention. The polyesteramide resin is a material capable of being worked and formed by itself; and can be worked and formed into packaging materials and packaging containers. If desired, any other resin and additive may be added to and mixed in the polyesteramide resin of the present invention, and the polyesteramide composition thus obtained can be worked and formed. The polyesteramide resin of the present invention can express sufficient oxygen absorption performance even though not containing a metal, and does not generate any offensive odor, and can have an extremely good transparency.

The “polyesteramide oligomer” of the present invention means a polymer having a limiting viscosity of less than 0.4 dl/g of the polyesteramide compound of the present invention. The polyesteramide oligomer is a material that cannot be worked and formed by itself. In many cases in general, an oligomer indicates a polymer having a number-average molecular weight of at most 1,000, but the polyesteramide oligomer of the present invention includes not only such an ordinary oligomer but also a polymer having a number-average molecular weight of less than 10,000.

The polyesteramide oligomer of the present invention is favorable for use as an oxygen absorbent, as capable of being filled in pouches or the like. In addition, the polyesteramide oligomer of the present invention is favorably used as a resin material or a resin additive. In case where the polyesteramide oligomer of the present invention is used as a resin material, the polyesteramide oligomer may be copolymerized with any other resin material to give a copolymer resin, and the copolymer resin may be worked and formed into packaging materials or packaging containers. In case where the polyesteramide oligomer of the present invention is used as a resin additive, the polyesteramide oligomer may be added to a resin to give a polyesteramide composition, which may be worked and formed into packaging materials or packaging containers. In this case, the polyesteramide oligomer can express sufficient oxygen absorption performance not detracting from the transparency and the mechanical strength of the resin. The copolymer resin or the polyesteramide composition obtained by the use of the polyesteramide oligomer of the present invention can express sufficient oxygen absorption performance even though not containing a metal, and does not generate any offensive odor.

In the polyesteramide compound of the present invention, the content of the tertiary hydrogen-containing carboxylic acid unit is from 0.1 to 50 mol %. When the content of the tertiary hydrogen-containing carboxylic acid unit is less than 0.1 mol %, then the compound could not express sufficient oxygen absorption performance. On the other hand, when the content of the tertiary hydrogen-containing carboxylic acid unit is more than 50 mol %, then the tertiary hydrogen content is too high, and if so, the physical properties such as the gas barrier property and the mechanical properties and the like of the polyesteramide compound may worsen; and in particular, when the tertiary hydrogen-containing carboxylic acid is an amino acid, then not only the heat resistance of the compound is poor since peptide bonds continue therein but also a cyclic product of a dimer of the amino acid is formed to interfere with polymerization. From the viewpoint of the oxygen absorption performance and other properties of the polyesteramide compound, the content of the tertiary hydrogen-containing carboxylic acid unit is preferably at least 0.2 mol %, more preferably at least 1 mol %, and is preferably at most 40 mol %, even more preferably at most 30 mol %.

In the polyesteramide compound of the present invention, the ester unit content is from 50 to 99.9 mol %, and from the viewpoint of the oxygen absorption performance and the polymer properties of the compound, the content is preferably at least 60 mol %, more preferably at least 70%, and is preferably at most 99.8 mol %, more preferably at most 99 mol %.

### 1-1. Ester Unit

The ester unit represented by the above-mentioned general formula (I) is a linear aliphatic ester unit.

In the general formula (I), X represents an alkylene group, and the carbon number of the alkylene group is preferably from 1 to 12, more preferably from 1 to 8, even more preferably from 1 to 6, still more preferably from 1 to 4. The alkylene group may be linear or branched.

The compound capable of constituting the ester unit represented by the formula (I) includes alkyl hydroxycarboxylates, and cyclic esters. One alone or two or more different types of these may be used here either singly or as combined.

The alkyl hydroxycarboxylate is an ester of a hydroxycarboxylic acid and an alcohol, and constitutes the ester unit represented by the above-mentioned general formula (I) through alcohol removal reaction in polymerization to give the polyesteramide compound. The carbon number of the alkyl hydroxycarboxylate is preferably from 3 to 30, more preferably from 3 to 10, even more preferably from 3 to 6.

The carbon number of the alcohol to constitute the alkyl hydroxycarboxylate is preferably from 1 to 6, more preferably from 1 to 4 from the viewpoint of the availability and the cost thereof. The alcohol of the type includes methanol, ethanol, propanol, isopropanol, n-butanol, isobutanol, tert-butanol, etc.

The carbon number of the hydroxycarboxylic acid to constitute the alkyl hydroxycarboxylate is preferably from 2 to 20, more preferably from 2 to 12, even more preferably from 2 to 6, still more preferably from 2 to 4. The position of the hydroxyl group in the hydroxycarboxylic acid is not specifically defined.

Specific examples of the hydroxycarboxylic acid include glycolic acid, L-lactic acid, D-lactic acid, 3-hydroxypropanoic acid, α-hydroxybutyric acid, a-hydroxyisobutyric acid, 3-hydroxybutanoic acid, 4-hydroxybutanoic acid, a-hydroxyvaleric acid, α-hydroxycaproic acid, α-hydroxyisocaproic acid, 6-hydroxycaproic acid, α-hydroxyheptanoic acid, α-hydroxyoctanoic acid, a-hydroxydecanoic acid, α-hydroxymyristic acid, α-hydroxystearic acid, etc.

Of the alkyl hydroxycarboxylates, preferred are alkyl glycolates in which the carbon number of the alkyl group is from 1 to 4 and which are obtained from glycolic acid and an alcohol having from 1 to 4 carbon atoms.

The cyclic ester includes lactones as well as intermolecular cyclic esters of two molecules of a hydroxycarboxylic acid (also referred to as cyclic dimers), and this constitutes the ester unit represented by the above-mentioned general formula (I) in ring-opening reaction for polymerization to give the polyesteramide compound.

The lactone includes β-propiolactone, β-butyrolactone, pivalolactone, γ-butyrolactone, δ-valerolactone, β-methyl-δ-valerolactone, ε-caprolactone, etc. The intermolecular cyclic ester of two molecules of a hydroxycarboxylic acid includes intermolecular cyclic esters of two molecules of the above-mentioned hydroxycarboxylic acid.

Of the cyclic esters, preferred are an intermolecular cyclic ester of two molecules of glycolic acid, or that is, glycolide, and L-lactide and D-lactide that are an intermolecular cyclic ester of two molecules of lactic acid; and more preferred is glycolide.

The method for producing glycolide is not specifically defined. In general, the glycolide may be produced through thermal depolymerization of a glycolic acid oligomer. For the thermal depolymerization of a glycolic acid oligomer, for example, referred to are the melt depolymerization method described in U.S. Pat. No. 2,668,162, the solid-phase depolymerization method described in JP-A 2000-119269, the solution depolymerization method described in JP-A 9-328481, etc. Also usable here is the glycolide that is obtained as a cyclic condensate of a chloroacetate salt, as reported by K. Chujo et al. in Die Makromolekulare Cheme, 100 (1967), 262-266.

As the compound capable of constituting the ester unit represented by the above-mentioned formula (I), usable here is a polymer of the above-mentioned alkyl hydroxycarboxylate or the cyclic ester. Specific examples of the polymer include polyglycolic acid (PGA), polylactic acid (PLA), etc. However, from the viewpoint of the polymerization reaction to give the polyesteramide compound, the degree of polymerization of the polymer is preferably low.

### 1-2. Tertiary Hydrogen-Containing Carboxylic Acid Unit

The tertiary hydrogen-containing carboxylic acid unit in the present invention has at least one amino group and at least one carboxyl group from the viewpoint of polymerization to give the polyesteramide compound. As specific examples, there are mentioned constituent units represented by the following general formulae (II) or (III):

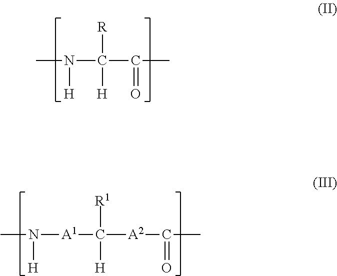

wherein, in the above-mentioned general formula (H) and (III), R and R¹ each independently represent a substituent, and A¹ and A² each independently represent a single bond or a divalent linking group, provided that the case where both A¹ and A² are single bonds in the general formula (III) is excluded.

The polyesteramide compound of the present invention contains a tertiary hydrogen-containing carboxylic acid unit. Containing such a tertiary hydrogen-containing carboxylic acid unit as the copolymerization component thereof, the polyesteramide compound of the present invention can exhibit excellent oxygen absorption performance even though not containing a transition metal.

In the present invention, the mechanism that the polyesteramide compound having a tertiary hydrogen-containing carboxylic acid unit could realize good oxygen absorption performance would be, though not clarified as yet, considered as follows: In the compound capable of constituting a tertiary hydrogen-containing carboxylic acid unit, an electron-attracting group and an electron-donating group bond to one and the same carbon atom, and therefore, owing to the phenomenon that is called a captodative effect of energically stabilizing the unpaired electrons existing on that carbon atom, an extremely stable radical could be formed. Specifically, a carboxyl group is an electron-attracting group, and since the carbon atom adjacent to the group, to which a tertiary hydrogen atom bonds, is an electron-poor (δ⁺) one, the tertiary hydrogen atom also becomes an electron-poor (δ⁺) one, therefore forming a radical as dissociated as a proton. In case where oxygen and water exist in this state, oxygen could react with the radical and therefore the compound could exhibit oxygen absorption performance. In this connection, it has been known that in an environment having a higher humidity and a higher temperature, the reactivity is higher.

In the above-mentioned general formulae (II) and (III), R and R¹ each represent a substituent. The substituent represented by R and R¹ in the present invention includes a halogen atom (e.g., a chlorine atom, a bromine atom, an iodine atom), an alkyl group (a linear, branched or cyclic alkyl group having from 1 to 15, preferably from 1 to 6 carbon atoms, for example, a methyl group, an ethyl group, an n-propyl group, an isopropyl group, a t-butyl group, an n-octyl group, a 2-ethylhexyl group, a cyclopropyl group, a cyclopentyl group), an alkenyl group (a linear, branched or cyclic alkenyl group having from 2 to 10, preferably from 2 to 6 carbon atoms, for example, a vinyl group, an allyl group), an alkynyl group (an alkynyl group having from 2 to 10, preferably from 2 to 6 carbon atoms, for example, an ethynyl group, a propargyl group), an aryl group (an aryl group having from 6 to 16, preferably from 6 to 10 carbon atoms, for example, a phenyl group, a naphthyl group), a heterocyclic group (a monovalent group having from 1 to 12, preferably from 2 to 6 carbon atoms, as derived from a 5-membered or 6-membered, aromatic or non-aromatic heterocyclic compound by removing one hydrogen atom therefrom, for example, a 1-pyrazolyl group, a 1-imidazolyl group, a 2-furyl group), a cyano group, a hydroxyl group, a nitro group, an alkoxy group (a linear, branched or cyclic alkoxy group having from 1 to 10, preferably from 1 to 6 carbon atoms, for example, a methoxy group, an ethoxy group), an aryloxy group (an aryloxy group having from 6 to 12, preferably from 6 to 8 carbon atoms, for example, a phenoxy group), an acyl group (a formyl group, an alkylcarbonyl group having from 2 to 10, preferably from 2 to 6 carbon atoms, or an arylcarbonyl group having from 7 to 12, preferably from 7 to 9 carbon atoms, for example, an acetyl group, a pivaloyl group, a benzoyl group), an amino group (an amino group, an alkylamino group having from 1 to 10, preferably from 1 to 6 carbon atoms, an anilino group having from 6 to 12, preferably from 6 to 8 carbon atoms, or a heterocyclic amino group having from 1 to 12, preferably from 2 to 6 carbon atoms, for example, an amino group, a methylamino group, an aniline group), a mercapto group, an alkylthio group (an alkylthio group having from 1 to 10, preferably from 1 to 6 carbon atoms, for example, a methylthio group, an ethylthio group), an arylthio group (an arylthio group having from 6 to 12, preferably from 6 to 8 carbon atoms, for example, a phenylthio group), a heterocyclic thio group (a heterocyclic thio group having from 2 to 10, preferably from 1 to 6 carbon atoms, for example, a 2-benzothiazolylthio group), an imido group (an imido group having from 2 to 10, preferably from 4 to 8 carbon atoms, for example, an N-succinimido group, an N-phthalimido group), etc.

Of the functional groups, those having a hydrogen atom may be further substituted with the above-mentioned group. For example, there are mentioned an alkyl group substituted with a hydroxyl group (e.g., a hydroxyethyl group), an alkyl group substituted with an alkoxy group (e.g., a methoxyethyl group), an alkyl group substituted with an aryl group (e.g., a benzyl group), an aryl group substituted with an alkyl group (e.g., a p-tolyl group), an aryloxy group substituted with an alkyl group (e.g., a 2-methylphenoxy group), etc., to which, however, the present invention is not limited.

In case where the functional group is further substituted, the above-mentioned carbon number does not include the carbon number of the additional substituent. For example, a benzyl group is considered as an alkyl group having 1 carbon atom and substituted with a phenyl group, but is not considered as an alkyl group substituted with a phenyl group and having 7 carbon atoms. Unless otherwise specifically indicated, the same shall apply to the carbon number referred to hereinunder.

In the general formula (III), A¹ and A² each represent a single bond or a divalent linking group. However, the general formula excludes a case where A¹ and A² are both single bonds. The divalent linking group includes, for example, a linear, branched or cyclic alkylene group (an alkylene group having from 1 to 12, preferably from 1 to 4 carbon atoms, for example, a methylene group, an ethylene group), an aralkylene group (an aralkylene group having from 7 to 30, preferably from 7 to 13 carbon atoms, for example, a benzylidene group), an arylene group (an arylene group having from 6 to 30, preferably from 6 to 15 carbon atoms, for example, a phenylene group), etc. These may further have a substituent. The substituent may include the functional groups exemplified hereinabove for the substituents represented by R and For example, there are mentioned an arylene group substituted with an alkyl group (for example, a xylylene group), etc., to which, however, the present invention is not limited.

Preferably, the polyesteramide compound of the present invention contains at least one of the constituent units represented by the above-mentioned general formula (II) or (III). Of those, more preferred is a carboxylic acid unit having a tertiary hydrogen atom at the a carbon atom (carbon atom adjacent to the carboxyl group), from the viewpoint of the availability of the starting material and of the advanced oxygen absorbability of the compound; and more preferred is the constituent unit represented by the general formula (II).

R in the general formula (II) is as mentioned above. Above all, more preferred are a substituted or unsubstituted alkyl group and a substituted or unsubstituted aryl group; even more preferred are a substituted or unsubstituted, linear or branched alkyl group having from 1 to 6 carbon atoms, and a substituted or unsubstituted aryl group having from 6 to 10 carbon atoms; and still more preferred are a substituted or unsubstituted alkyl group having from 1 to 4 carbon atoms, and a substituted or unsubstituted phenyl group.

Preferred examples of R include a methyl group, an ethyl group, an n-propyl group, an isopropyl group, an n-butyl group, a t-butyl group, a 1-methylpropyl group, a 2-methylpropyl group, a hydroxymethyl group, a 1-hydroxyethyl group, a mercaptomethyl group, a methylsulfanylethyl group, a phenyl group, a naphthyl group, a benzyl group, a 4-hydroxybenzyl group, etc., to which, however, the present invention is not limited. Of those, more preferred are a methyl group, an ethyl group, a butyl group and a benzyl group.

The compound capable of constituting the constituent unit represented by the general formula (II) includes α-amino acids such as alanine, 2-aminobutyric acid, valine, norvaline, leucine, norleucine, tert-leucine, isoleucine, serine, threonine, cysteine, methionine, 2-phenylglycine, phenylalanine, tyrosine, histidine, tryptophane, proline, etc., to which, however, the present invention is not limited.

The compound capable of constituting the constituent unit represented by the general formula (III) includes β-amino acids such as 3-aminobutyric acid, etc., to which, however, the invention is not limited.

These may be any of a D-form, an L-form or a racemic form, and may also be an allo-form. One alone or two or more of these may be used here either singly or as combined.

Of those, more preferred is an α-amino acid having a tertiary hydrogen atom at the a carbon atom, from the viewpoint of the availability of the starting material and of the advanced oxygen absorbability of the compound. Of the α-amino acid, most preferred is alanine from the viewpoint of the availability, the cost and the polymerizability thereof and of the low yellow index (YI) of the polymer. Alanine has a relatively low molecular weight, and the copolymerization ratio thereof per gram of the polyesteramide compound of the present invention is therefore high, and accordingly, the oxygen absorption performance per gram of the polyesteramide compound with alanine is good.

The purity of the compound capable of constituting the tertiary hydrogen-containing carboxylic acid unit is preferably at least 95%, from the viewpoint of the influence thereof on the polymerization such as delay in polymerization rate thereof as well as on the quality such as the yellow index of the polymer, more preferably at least 98.5%, even more preferably at least 99%. The amount of sulfate ion and ammonium ion to be contained in the compound as impurities therein is preferably at most 500 ppm, more preferably at most 200 ppm, even more preferably at most 50 ppm.

### 1-3. Degree of Polymerization of Polyesteramide Compound

For the degree of polymerization of the polyesteramide compound of the present invention, used is a limiting viscosity thereof since the use of the compound is similar to that of polyester resin. The limiting viscosity of the polyesteramide compound of the present invention is preferably from 0.1 dl/g to 1.5 dl/g.

In case where the polyesteramide compound of the present invention is a polyesteramide resin, the limiting viscosity thereof is preferably from 0.4 to 1.5 dl/g, from the viewpoint of the shapability and workability thereof and from the mechanical properties, the strength and the odor of shapes thereof, more preferably from 0.5 to 1.2 dl/g, even more preferably from 0.6 to 1.0 dl/g. However, in case where the polyesteramide resin of the present invention is used as an additive, a modifier or the like for other thermoplastic resins, the range should not apply thereto.

In case where the polyesteramide compound of the present invention is a polyesteramide oligomer, the limiting viscosity thereof is preferably from 0.1 dl/g to less than 0.4 dl/g, from the viewpoint of the handleability, the reactivity and the thermal stability thereof, more preferably from 0.15 to 0.35 dl/g, even more preferably from 0.15 to 0.3 dl/g.

The limiting viscosity may be determined according to the method described in Examples given hereinunder. The limiting viscosity of the polymer can be controlled to fall within the above mentioned range by suitably defining the polymerization time, the catalyst amount, the vacuum degree in polymerization, etc.

### 2. Production Method for Polyesteramide Compound

The polyesteramide compound of the present invention can be produced through polycondensation of a cyclic ester component and/or an alkyl hydroxycarboxylate component capable of constituting the above-mentioned ester unit, and a tertiary hydrogen-containing carboxylic acid component capable of constituting the above-mentioned tertiary hydrogen-containing carboxylic acid unit, in which the degree of polymerization can be controlled by controlling the polycondensation condition, etc. A small amount of a monoamine or a monocarboxylic acid as well as a monoalcohol or a higher alcohol such as lauryl alcohol, which serves as a molecular weight regulating agent, may be added to the system during polycondensation.

The polycondensation method for the polyesteramide compound of the present invention is not specifically defined, for which is applicable any conventional known method. For example, there are mentioned a melt polymerization method and a solution polymerization, such as a transesterification method that comprises reacting a methyl ester of a polycarboxylic acid component and a polyalcohol component and optionally the above-mentioned copolymerization component in the presence of a transesterification catalyst and removing the formed methanol through evaporation for transesterification followed by adding thereto a polymerization catalyst for promoting polycondensation, and a direct esterification method that comprises directly reacting a polycarboxylic acid component and a polyalcohol component and optionally the above-mentioned copolymerization component and removing the formed water through evaporation for esterification followed by adding thereto a polymerization catalyst for promoting polycondensation. For efficiently producing the polyesteramide compound of the present invention, preferred is the direct esterification method from the viewpoint of the reactivity of the constituent components.

Regarding the timing for adding the tertiary hydrogen-containing carboxylic acid component in the direct esterification method, the component may be added to the system in any stage of the polycondensation step; however, from the viewpoint that the tertiary hydrogen-containing carboxylic acid component could be surely incorporated into the polymer, preferably, the component is added to the system in the stage where the degree of polymerization is low, and for example, the tertiary hydrogen-containing carboxylic acid component may be added in the stage of esterification of the polycarboxylic acid component and the polyalcohol component, or in the stage where the polycondensation catalyst is added to the prepolyrner.

### 2-1. Catalyst and Additive

The interesterification catalyst, the esterification catalyst and the etherification inhibitor to be used in production of the polyesteramide compound, and also the polymerization catalyst as well as various stabilizers such as thermal stabilizer and light stabilizer, and the polymerization-controlling agent to be used in polymerization may be any conventional known ones.

As the interesterification catalyst and the esterification catalyst, there are exemplified compounds with manganese, cobalt, zinc, titanium, calcium or the like. As the etherification inhibitor, there are exemplified amine compounds, etc.

As the polymerization catalyst, there are exemplified compounds including germanium, antimony, titanium, aluminium or the like. For example, the germanium-containing compound includes amorphous germanium dioxide, crystalline germanium dioxide, germanium chloride, germanium tetraethoxide, germanium tetra-n-butoxide, germanium phosphite, etc. The amount of the compound to be used is preferably so controlled that the germanium atom concentration in the polyesteramide compound could be from 5 to 150 ppm, more preferably from 10 to 100 ppm, even more preferably from 15 to 70 ppm.

The antimony-containing compound includes antimony trioxide, antimony acetate, antimony tartrate, antimony potassium tartrate, antimony oxychloride, antimony glycolate, antimony pentoxide, triphenylantimony, etc. The amount of the compound to be used is preferably so controlled that the antimony atom concentration in the polyesteramide compound could be from 10 to 400 ppm, more preferably from 20 to 350 ppm, even more preferably from 30 to 300 ppm.

The titanium-containing compound includes tetra-alkyl titanates such as tetraethyl titanate, tetraisopropyl titanate, tetra-n-propyl titanate, tetra-n-butyl titanate, etc., and their partial hydrolyzates; titanyl oxalate compounds such as titanyl oxalate, titanylammonium oxalate, titanylsodium oxalate, titanylpotassium oxalate, titanylcalcium oxalate, titanylstrontium oxalate, etc.; as well as titanium trimellitate, titanium sulfate, titanium chloride, etc. The amount of the compound to be used is preferably so controlled that the titanium atom concentration in the polyesteramide compound could be from 0.5 to 300 ppm, more preferably from 1 to 200 ppm, even more preferably from 3 to 100 ppm.

The aluminium-containing compound includes carboxylate salts such as aluminium formate, aluminium acetate, aluminium propionate, aluminium oxalate, etc.; inorganic acid salts such as oxides, aluminium hydroxide, aluminium chloride, aluminium chlorohydroxide, aluminium carbonate, etc.; aluminium alkoxides such as aluminium methoxide, aluminium ethoxide, etc.; aluminium chelate compounds such as aluminium acetylacetonate, aluminium acetylacetate, etc.; organic aluminium compounds such as trimethylaluminium, triethylaluminium, etc., and their partial hydrolyzates, etc. The amount of the compound to be used is preferably so controlled that the aluminium atom concentration in the polyesteramide compound could be from 1 to 400 ppm, more preferably from 3 to 300 ppm, even more preferably from 5 to 200 ppm.

In producing the polyesteramide compound of the present invention, an alkali metal compound or an alkaline earth metal compound may be sued. The alkali metal compound and the alkaline earth metal compound include alkali metal or alkaline earth metal carboxylate salts, alkoxides, etc. The amount of the compound to be used is preferably so controlled that the alkali metal or alkaline earth metal atom concentration in the polyesteramide compound could be from 0.1 to 200 ppm, more preferably from 0.5 to 150 ppm, even more preferably from 1 to 100 ppm.

In producing the polyesteramide compound of the present invention, one or more of phosphoric acid, phosphorous acid, phosphonic acid and their derivatives may be used as a thermal stabilizer. For example, there are mentioned phosphoric acid, trimethyl phosphate, triethyl phosphate, tributyl phosphate, triphenyl phosphate, monomethyl phosphate, dimethyl phosphate, monobutyl phosphate, dibutyl phosphate, phosphorous acid, trimethyl phosphite, triethyl phosphite, tributyl phosphite, methylphosphonic acid, dimethyl methylphosphonate, dimethyl ethylphosphonate, diethyl phenylphosphonate, diphenyl phenylphosphonate, etc. The amount of the compound to be used is preferably so controlled that the phosphorus atom concentration in the polyesteramide compound could be from 1 to 200 ppm, more preferably from 2 to 150 ppm, even more preferably from 3 to 100 ppm.

In producing the polyesteramide compound of the present invention, a higher alcohol such as lauryl alcohol may be added to the system for controlling the weight-average molecular weight of the polymer. A polyalcohol such as glycerin may also be added for improving the physical properties of the polymer. In addition, other additives mentioned below may be added to the system.

### 2-2. Step of Increasing Degree of Polymerization

The polyesteramide compound produced according to the above-mentioned polymerization method can be used directly as it is, however, the compound may be processed in a step of further increasing the degree of polymerization thereof. The step of increasing the degree of polymerization includes reactive extrusion in an extruder, solid-phase polymerization, etc. As the heating apparatus for use for solid-phase polymerization, preferred are a continuous heating and drying apparatus; a rotary drum-type heating apparatus such as a tumble drier, a conical drier, a rotary drier, etc.; and a conical heating apparatus equipped with a rotary blade inside it, such as a Nauta mixer, etc. Not limited to these, any ordinary method and apparatus are usable in the present invention. In particular, for solid-phase polymerization to give the polyesteramide compound, preferred is use of a rotary drum-type heating apparatus among the above, since the system can be airtightly sealed up and the polycondensation can be readily promoted therein in a condition where oxygen to cause discoloration is eliminated.

### 3. Polyesteramide Composition

The polyesteramide composition of the present invention is a composition containing the polyesteramide compound of the present invention. The polyesteramide composition of the present invention is a mixture to be obtained by adding various additives and various resins to the polyesteramide resin or the polyesteramide oligomer of the present invention followed by mixing them, and in the mixture, the polyesteramide resin or the polyesteramide oligomer may react with the additives and the resins added thereto.

### 3-1. Additive

Depending on the desired use and performance, additives such as lubricant, crystallization nucleating agent, whitening inhibitor, delustering agent, heat-resistant stabilizer, weather-resistant stabilizer, UV absorbent, plasticizer, flame retardant, antistatic agent, discoloration inhibitor, antioxidant, impact resistance improver, etc., may be added to the polyesteramide compound of the present invention to give a polyesteramide composition. These additives may be optionally added thereto within a range not detracting from the advantage of the present invention.

The polyesteramide compound of the present invention may be mixed with the additives in any heretofore known method, for which, however, preferred is inexpensive dry mixing that hardly receives thermal history. For example, there is mentioned a method where the polyesteramide compound and the above-mentioned additives are added to a tumbler and mixed therein by rotating the tumbler. In the present invention, also employable is a method where a viscous liquid is adhered to the polyesteramide compound as a spreading agent and thereafter the additives are added to and mixed with the compound, for preventing the polyesteramide compound and the additives from separating after mixing in dry. As the spreading agent, there are mentioned surfactants, etc.; however, not limited thereto, any known one is employable in the present invention.

### 3-1-1. Whitening Inhibitor

In the polyesteramide composition of the present invention, preferably, a diamide compound and/or a diester compound are added to the polyesteramide compound for preventing the composition from whitening after hot water treatment or after long-term aging. The diamide compound and/or the diester compound are effective for preventing whitening due to oligomer precipitation. The diamide compound and the diester compound may be used alone, or may be used as combined.

The diamide compound for use in the present invention is preferably a diamide compound obtained from an aliphatic dicarboxylic acid having from 8 to 30 carbon atoms and a diamine having from 2 to 10 carbon atoms. An aliphatic dicarboxylic acid having at least 8 carbon atoms and a diamine having at least two carbon atoms are expected to realize the whitening-preventing effect. On the other hand, an aliphatic dicarboxylic acid having at most 30 carbon atoms and a diamine having at most 10 carbon atoms may give a diamide compound well and uniformly dispersible in the polyesteramide composition. The aliphatic dicarboxylic acid may have a side chain or a double bond, but a linear saturated aliphatic dicarboxylic acid is preferred for use herein. One alone or two or more different types of such diamide compounds may be used here either singly or as combined.

The aliphatic dicarboxylic acid includes stearic acid (C18), eicosanoic acid (C20), behenic acid (C22), montanic acid (C28), triacontanoic acid (C30), etc. The diamine includes ethylenediamine, butylenediamine, hexanediamine, xylylenediamine, bis(aminomethyl)cyclohexane, etc. Diamide compounds to be obtained by combining these are preferred here.

Preferred is a diamide compound to be obtained from an aliphatic dicarboxylic acid having from 8 to 30 carbon atoms and a diamine mainly comprising ethylenediamine, or a diamide compound to be obtained from an aliphatic dicarboxylic acid mainly comprising montanic acid and a diamine having from 2 to 10 carbon atoms; and more preferred is a diamide compound to be obtained from an aliphatic dicarboxylic acid mainly comprising stearic acid and a diamine mainly comprising ethylenediamine.

As the diester compound for use in the present invention, preferred is a diester compound to be obtained from an aliphatic dicarboxylic acid having from 8 to 30 carbon atoms and a diol having from 2 to 10 carbon atoms. An aliphatic dicarboxylic acid having at least 8 carbon atoms and a diamine having at least 2 carbon atoms are expected to exhibit the whitening preventing effect. On the other hand, an aliphatic dicarboxylic acid having at most 30 carbon atoms and a diol having at most 10 carbon atoms realize good and uniform dispersion in the polyesteramide composition. The aliphatic dicarboxylic acid may have a side chain or a double bond, but preferred here is a linear saturated aliphatic dicarboxylic acid. One alone or two or more different types of such diester compounds may be used here either singly or as combined.

The aliphatic dicarboxylic acid includes stearic acid (C18), eicosanoic acid (C20), behenic acid (C22), montanic acid (C28), triacontanoic acid (C30), etc. The diol includes ethylene glycol, propanediol, butanediol, hexanediol, xylylene glycol, cyclohexanedimethanol, etc. Diester compounds to be obtained by combining these are preferred here.

Especially preferred is a diester compound to be obtained from an aliphatic dicarboxylic acid comprising mainly montanic acid and a diol comprising mainly ethylene glycol and/or 1,3-butanediol.

In the present invention, the amount to be added of the diamide compound and/or the diester compound may be from 0.005 to 0.5 parts by mass relative to 100 parts by mass of the polyesteramide compound, preferably from 0.05 to 0.5 parts by mass, more preferably from 0.12 to 0.5 parts by mass. When the compound is added in an amount of at least 0.005 parts by mass relative to 100 parts by mass of the polyesteramide compound and when the compound is combined with a crystallization nucleating agent, then a synergistic effect for whitening prevention is expected. When the amount of the compound is at most 0.5 parts by mass relative to 100 parts by mass of the polyesteramide compound, then the haze value of the shapes to be obtained by forming the polyesteramide composition of the present invention can be kept low.

### 3-1-2. Crystallization Nucleating Agent

Preferably, a crystallization nucleating agent is added to the polyesteramide composition of the present invention from the viewpoint of improving the transparency of the composition. The agent is effective not only for improving the transparency but also for whitening prevention through crystallization after hot water treatment or after long-term aging; and by adding the crystallization nucleating agent to the polyesteramide compound, the crystal size can be reduced to at most ½ of the wavelength of visible light. When the diamide compound and/or the diester compound is used here along with the crystallization nucleating agent, their synergistic effect realizes much more excellent whitening prevention than the degree thereof expected from the whitening preventing effect of the individual ingredients.

Inorganic crystallization nucleating agents usable in the present invention are those generally used for thermoplastic resins, including glass fillers (glass fibers, milled glass fibers, glass flakes, glass beads, etc.), calcium silicate fillers (wollastonite, etc.), mica, talc (powdery talc, or granular talc with rosin as a binder, etc.), kaolin, potassium titanate whiskers, boron nitride, clay such as phyllosilicate, nanofillers, carbon fibers, etc. Two or more of these may be used here as combined. Preferably, the maximum diameter of the inorganic crystallization nucleating agent is from 0.01 to 5 μm. In particular, powdery talc having a particle size of at most 3.0 μm is preferred, powdery talc having a particle size of from 1.5 to 3.0 μm or so is more preferred, and powdery talc having a particle size of at most 2.0 μm is even more preferred. Granular talc prepared by adding rosin as a binder to the powdery talc is especially preferred since the dispersion state thereof in the polyesteramide composition is good. Organic crystallization nucleating agents preferred for use herein are micro-level to nano-level size bimolecular membrane capsules containing a crystallization nucleating agent, as well as bis(benzylidene)sorbitol-type or phosphorus-containing transparent crystallization nucleating agents, rosinamide-type gelling agents, etc. Especially preferred are bis(benzylidene)sorbitol-type crystallization nucleating agents.

The amount of the crystallization nucleating agent to be added is preferably from 0.005 to 2.0 parts by mass relative to 100 parts by mass of the polyesteramide compound, more preferably from 0.01 to 1.5 parts by mass. At least one such crystallization nucleating agent is added to the polyesteramide compound along with the diamide compound and/or the diester compound added thereto, thereby attaining the synergistic whitening preventing effect. Especially preferably, the inorganic crystallization nucleating agent such as talc or the like is added in an amount of from 0.05 to 1.5 parts by mass relative to 100 parts by mass of the polyesteramide compound, and the organic crystallization nucleating agent such as bis(benzylidene)sorbitol-type crystallization nucleating agent or the like is added in an amount of from 0.01 to 0.5 parts by mass relative to 100 parts by mass of the polyesteramide compound.

The bis(benzylidene)sorbitol-type crystallization nucleating agent is selected from bis(benzylidene)sorbitol and bis(alkylbenzylidene)sorbitol, and is a condensation product (diacetal compound) to be produced through acetalization of sorbitol and benzaldehyde or alkyl-substituted benzaldehyde; and this can be conveniently produced according to various methods known in the art. In this, the alkyl may be linear or cyclic, and may be saturated or unsaturated. An ordinary production method comprises reaction of 1 mol of D-sorbitol and about 2 mol of aldehyde in the presence of an acid catalyst. The reaction temperature may vary in a broad range depending on the properties (melting point, etc.) of the aldehyde to be used as the starting material for the reaction. The reaction medium may be an aqueous medium or a nonaqueous medium. One preferred method for preparing the diacetal for use in the present invention is described in U.S. Pat. No. 3,721,682. The disclosed contents are limited to benzylidene sorbitols; however, the bis(alkylbenzylidene)sorbitol for use in the present invention can be conveniently produced according to the method disclosed in the reference.

Specific examples of the bis(benzylidene)sorbitol-type crystallization nucleating agent (diacetal compounds) include bis(p-methylbenzylidene)sorbitol, bis(p-ethylbenzylidene)sorbitol, bis(n-propylbenzylidene)sorbitol, bis(p-isopropybenzylidene)sorbitol, bis(p-isobutylbenzylidene)sorbitol, bis(2,4-dimethylbenzylidene)sorbitol, bis(3,4-dimethylbenzylidene)sorbitol, bis(2,4,5-trimethylbenzylidene)sorbitol, bis(2,4,6-trimethylbenzylidene)sorbitol, bis(4-biphenylbenzylidene)sorbitol, etc.

Examples of the alkyl-substituted benzaldehyde suitable for preparing the bis(benzylidene)sorbitol-type crystallization nucleating agent include p-methylbenzaldehyde, n-porpylbenzaldehyde, p-isopropylbenzaldehyde, 2,4-dimethylbenzladehyde, 3,4-dimethylbenzaldehyde, 2,4,5-trimethylbenzaldehyde, 2,4,6-trimethylbenzaldehyde, 4-biphenylbenzaldehyde.

When the crystallization nucleating agent such as talc, mica, clay or the like is added to the polyesteramide compound, then the crystallization speed of the compound is accelerated by at least two times that of the polyesteramide compound to which the agent is not added. This would cause no problem in injection molding use that requires a large number of molding cycles; however, for deep-drawn cups to be formed from a stretched film or sheet, when the crystallization speed is too high, the film or sheet could not be stretched owing to crystallization, or may be broken or may have other problems of stretching unevenness, or that is, in these cases, the moldability greatly worsens. However, the bis(benzylidene)sorbitol-type crystallization nucleating agent does not accelerate the crystallization speed of the polyesteramide compound even when added to the compound, and therefore, the agent is preferably used for deep-drawn cups to be formed from a stretched film or sheet.

Further, it has been found that the bis(benzylidene)sorbitol-type crystallization nucleating agent is effective not only for whitening prevention but also for improving the oxygen barrier property of the polyesteramide compound when added to the compound. Use of the bis(benzylidene)sorbitol-type crystallization nucleating agent that realizes both effects of whitening prevention and oxygen barrier property improvement is especially preferred here.

The polyesteramide composition of the present invention, to which is added a phyllosilicate, can be used as a barrier layer, and the composition can enhance not only the oxygen barrier property of shapes but also the other barrier property to other gases such as carbon dioxide, etc.

The phyllosilicate is a 2-octahedral or 3-octahedral phyllosilicate having a charge density of from 0.25 to 0.6. The 2-octahedral phyllosilicate includes montmorillonite, beidellite, etc.; and the 3-octahedral phyllosilicate includes hectorite, saponite, etc. Of those, preferred is montmorillonite.

The phyllosilicate is preferably one in which the layer-to-layer distance is broadened by previously bringing the phyllosilicate into contact with an organic swelling agent such as a polymer compound, an organic compound or the like. As the organic swelling agent, preferred for use herein is a quaternary ammonium salt, and more preferred is a quaternary ammonium salt having at least one alkyl or alkenyl group with 12 or more carbon atoms.

Specific examples of the organic swelling agent include trimethylalkylammonium salts such as trimethyldodecylammonium salts, trimethyltetradecylammonium salts, trimethylhexadecylammonium salts, trimethyloctadecylammonium salts, trimethyleicosylammonium salts, etc.; trimethylalkenylammonium salts such as trimethyloctadecenylammonium salts, trimethyloctadecadienylammonium salts, etc.; triethylalkylammonium salts such as triethyldodecylammonium salts, triethyltetradecylammonium salts, triethylhexadecylammonium salts, triethyloctadecylammonium salts, etc.; tributylalkylammonium salts such as tributyldodecylammonium salts, tributyltetradecylammonium salts, tributylhexadecylammonium salts, tributyloctadecylammonium salts, etc.; dimethyldialkylammonium salts such as dimethyldidodecylammonium salts, dimethylditetradecylammonium salts, dimethyldihexadecylammonium salts, dimethyldioctadecylammonium salts, dimethylditallowammonium salts, etc.; dimethyldialkenylammonium salts such as dimethyldioctadecenylammonium salts, dimethyldioctadecadienylammonium salts, etc.; diethyldialkylammonium salts such as diethyldidodecylammonium salts, diethylditetradecylammonium salts, diethyldihexadecylammonium salts, diethyldioctadecylammonium salts, etc.; dibutyldialkylammonium salts such as dibutyldidodecylammonium salts, dibutylditetradecylammonium salts, dibutyldihexadecylammonium salts, dibutyldioctadecylammonium salts, etc.; methylbenzyldialkylammonium salts such as methylbenzyldihexadecylammonium salts, etc.; dibenzyldialkylammonium salts such as dibenzyldihexadecylammonium salts, etc.; trialkylmethylammonium salts such as tridodecylmethylammonium salts, tritetradecylmethylammonium salts, trioctadecylmethylammonium salts, etc.; trialkylethylammonium salts such as tridodecylethylammonium salts, etc.; trialkylbutylammonium salts such as tridodecylbutylammonium salts, etc.; co-amino acids such as 4-amino-n-butyric acid, 6-amino-n-caproic acid, 8-aminocaprylic acid, 10-aminodecanoic acid, 12-aminododecanoic acid, 14-aminotetradecanoic acid, 16-aminohexadecanoic acid, 18-aminooctadecanoic acid, etc. In addition, also usable here as an organic swelling agent are ammonium salts containing a hydroxyl group and/or an ether group, above all, quaternary ammonium salts containing at least one alkylene glycol residue are also usable here, such as methyldialkyl(PAG)ammonium salts, ethyldialkyl(PAG)ammonium salts, butyldialkyl(PAG)ammonium salts, dimethylbis(PAG)ammonium salts, diethylbis(PAG)ammonium salts, dibutylbis(PAG)ammonium salts, methylalkylbis(PAG)ammonium salts, ethylalkylbis(PAG)ammonium salts, butylalkylbis(PAG)ammonium salts, methyltri(PAG)ammonium salts, ethyltri(PAG)ammonium salts, butyltri(PAG)ammonium salts, tetra(PAG)ammonium salts (in which alkyl means an alkyl group having at least 12 carbon atoms such as dodecyl, tetradecyl, hexadecyl, octadecyl, eicosyl, etc.; and PAG means a polyalkylenes glycol residue, preferably a polyethylene glycol residue or a polypropylene glycol residue having at most 20 carbon atoms). Above all, preferred are trimethyldodecylammonium salts, trimethyltetradecylammonium salts, trimethylhexadecylammonium salts, trimethyloctadecylammonium salts, dimethyldidodecylammonium salts, dimethylditetradecylammonium salts, dimethyldihexadecylammonium salts, dimethyldioctadecylamtnonium salts, dimethylditallowammonium salts. One alone or two or more different types of these organic swelling agents may be used here either singly or as combined.

In the present invention, preferably, the phyllosilicate salt treated with an organic swelling agent is added in an amount of from 0.5 to 8 parts by mass relative to 100 parts by mass of the polyesteramide compound, more preferably from 1 to 6 parts by mass, even more preferably from 2 to 5 parts by mass. When the amount of the phyllosilicate salt added is less than 0.5 parts by mass, then it is unfavorable since the effect thereof to improve the gas barrier property of the polyesteramide composition is poor. On the other hand, when more than 8 parts by mass, it is also unfavorable since the gas barrier layer would get cloudy therefore detracting from the transparency of containers.

In the polyesteramide composition, preferably, the phyllosilicate salt is uniformly dispersed, not locally aggregated therein. Uniform dispersion as referred to herein means that the phyllosilicate salt particles are tabularly separated from each other, and at least 50% thereof are spaced from each other via an interlayer distance of at least 5 nm, in the polyesteramide composition. The interlayer distance as referred to herein means the distance between centroids of the tabular particles. A larger interlayer distance means a better dispersion condition; and the dispersion having a larger interlayer distance could provide a better appearance such as better transparency of shapes, and could enhance more the gas barrier property for oxygen, carbon dioxide and others of shapes.

### 3-1-3. Gelation Preventing/Fish Eyes Reducing Agent

In the polyesteramide composition of the present invention, preferably, at least one carboxylate salt selected from sodium acetate, potassium acetate, magnesium acetate, calcium stearate, magnesium stearate, sodium stearate and their derivatives is added to the polyesteramide compound. The derivatives include metal 12-hydroxystearates such as calcium 12-hydroxystearate, magnesium 12-hydroxystearate, sodium 12-hydroxystearate, etc. Adding the carboxylate salt prevents gelation of the polyesteramide compound during working and forming the polyesteramide composition and reduces fish eyes in the resulting shapes, therefore enhancing the formability and the workability of the composition.

The amount of the carboxylate salt to be added is preferably from 400 to 10,000 ppm as the concentration thereof in the polyesteramide composition, more preferably from 800 to 5,000 ppm, even more preferably from 1,000 to 3,000 ppm. When the amount is at least 400 pm, then the polyesteramide compound can be prevented from being thermally deteriorated and can be prevented from gelling. On the other hand, when at most 10,000 ppm, then the polyesteramide composition does not fail to be shaped and does not discolor or whiten. When a carboxylate salt of a basic substance exists in a molten polyesteramide compound, then the thermal degradation of the polyesteramide compound could be retarded and the formation of a gel that is considered to be a final degraded product could be prevented. The above-mentioned carboxylate salts are excellent in handleability, and among these, metal stearates are inexpensive and have an additional effect as a lubricant, and are therefore preferred for use herein as capable of more stabilizing the operation of working and forming the polyesteramide composition. The morphology of the carboxylate salt is not specifically defined. Preferably, the salt is powdery and has a small particle size as it is easy to uniformly disperse the salt in the polyesteramide composition in dry mixing. Concretely, the particle size is preferably at most 0.2 mm.

### 3-1-4. Antioxidant

Preferably, an antioxidant is added to the polyesteramide composition of the present invention from the viewpoint of controlling the oxygen absorption performance of the composition and inhibiting the physical properties of the composition from worsening. Examples of the antioxidant include a copper-based antioxidant, a hindered phenol-type antioxidant, a hindered amine-type antioxidant, a phosphorus-containing antioxidant, a thio-type antioxidant, etc. Above all, preferred are a hindered phenol-type antioxidant and a phosphorus-containing antioxidant.

Specific examples of the hindered phenol-type antioxidant include triethylene glycol bis[3-(3-t-butyl-5-methyl-4-hydroxyphenyl)propionate, 4,4′-butylidene-bis(3-methyl-6-t-butylphenol), 1,6-hexanediol bis[3-(3,5-di-t-butyl-4-hydroxyphenyl)propionate, 2,4-bis-(n-octylthio-6-(4-hydroxy-3,5-di-t-butylanilino)-1,3,5-triazine, pentaerythrityl tetrakis[3-(3,5-di-t-butyl-4-hydroxyphenyl)propionate], 2,2-thiodiethylene bis[3-(3,5-di-t-butyl-4-hydroxyphenyl)propionate], octadecyl-3-(3,5-di-t-butyl-4-hydroxyphenyl)propionate, 2,2-thiobis(4-methyl-6-1-butylphenol), N,N′-hexamethylenebis(3,5-di-t-butyl-4-hydroxy-hydroxycinnamide), 3,5-di-t-butyl-4-hydroxy-benzylphosphonate-diethyl ester, 1,3,5-trimethyl-2,4,6-tris(3,5-di-butyl-4-hydroxybenzyl)benzene, ethyl calcium bis(3,5-di-t-butyl-4-hydroxybenzyl)sulfonate, tris-(3,5-di-t-butyl-4-hydroxybenzyl) isocyanurate, 2,6-di-t-butyl-p-cresol, butylated hydroxyanisole, 2,6-di-t-butyl-4-ethylphenol, stearyl-β-(3,5-di-t-butyl-4-hydroxyphenyl)propionate, 2,2′-methylenebis-(4-methyl-6-t-butylphenol), 2,2′-methylenebis(4-ethyl-6-t-butylphenol), 4,4′-thiobis-(3-methyl-6-t-butylphenol), octylated diphenylamine, 2,4-bis[(octylthio)methyl]-O-cresol, isooctyl 3-(3,5-di-t-butyl-4-hydroxyphenyl)propionate, 4,4′-butylidenebis(3-methyl-6-t-butylphenol), 3,9-bis[1,1-dimethyl-2-[β-(3-t-butyl-4-hydrorxy-5-methylphenyl)propionyloxy]ethyl]-2,4,8,10-tetroxaspiro[5,5]undecane, 1,1,3-tris(2-methyl-4-hydroxy-5-t-butylphenyl)butane, 1,3,5-trimethyl-2,4,6-tris(3,5-di-t-butyl-4-hydroxybenzyl)benzene, bis[3,3′-bis-(4′-hydroxy-3′-t-butylphenyl)butyric acid]glycol ester, 1,3,5-tris(3′,5′-di-t-butyl-4′-hydroxybenzyl)-sec-triazine-2,4,6-(1H,3H,5H)trione, d-α-tocopherol, etc. These may be used here either alone or as combined. Specific examples of commercial products of hindered phenol compounds include BASF's Irganox 1010 and Irganox 1098 (both trade names).

Specific examples of the phosphorus-containing antioxidant include organic phosphorus compounds such as triphenyl phosphite, trioctadecyl phosphite, tridecyl phosphite, trinonylphenyl phosphite, diphenylisodecyl phosphite, bis(2,6-di-tert-butyl-4-methylphenyl)pentaerythritol diphosphite, bis(2,4-di-tert-butylphenyl)pentaerythritol diphosphite, tris(2,4-di-tert-butylphenyl) phosphite, distearylpentaerythritol diphosphite, tetra(tridecyl-4,4′-isopropylidenediphenyl) diphosphite, 2,2-methylenebis(4,6-di-tert-butylphenyl)octyl phosphite, etc. These may be used here either alone or as combined.

The content of the antioxidant in the polyesteramide composition is not limited, falling within a range not detracting from the properties of the composition. However, from the viewpoint of controlling the oxygen absorption performance of the composition and inhibiting the physical properties of the composition from worsening, the content is preferably from 0.001 to 3 parts by mass relative to 100 parts by mass of the polyesteramide compound of the present invention, more preferably from 0.01 to 1 part by mass.

### 3-1-5. Impact Resistance Improver

An impact resistance improver may be added to the amide composition containing the polyesteramide of the present invention for improving the impact resistance of the composition and the pinhole resistance and the flexibility of the films of the composition. The impact resistance improver to be added includes polyolefin, polyamide elastomer, hydrogenated styrene-butadiene copolymer resin, ionomer, ethylene-ethyl acrylate copolymer resin, maleic anhydride-modified ethylene-ethyl acrylate copolymer resin, ethylene-methacrylic acid copolymer resin, nylon 6, 66, 12, nylon 12, nylon 12 elastomer, ethylene-propylene copolymer elastomer, polyester elastomer, etc. The amount of the impact resistance improver to be added is preferably from 1 to 10% by mass, more preferably from 1 to 5% by mass, even more preferably from 2 to 3% by mass. When the added amount is too large, then the transparency and the gas barrier property of the composition may lower. When the added amount is too small, then the impact resistance of the composition and the pinhole resistance and the flexibility of the films of the composition could not be enhanced so much.

### 3-2. Resin

The polyesteramide compound of the present invention may be mixed with various resins in accordance with the intended use and performance to give a polyesteramide composition. Not specifically defined, the resin to be mixed with the polyesteramide compound of the present invention is preferably at least one selected from a group consisting of polyolefins, polyesters, polyamides, polyvinyl alcohols and vegetable-derived resins.

Of those, preferred is blending with a resin having a high oxygen barrier performance such as polyester, polyamide and polyvinyl alcohol, for effectively exhibiting the oxygen absorbing effect.

Any conventional known method is employable for mixing the polyesteramide compound of the present invention with resin, but preferred is melt-mixing. In case where the polyesteramide compound of the present invention is melt-mixed with a resin and formed into desired pellets or shapes, they may be melt-blended with an extruder or the like. The extruder may be a single-screw or double-screw extruder, but from the viewpoint of the mixing performance thereof, preferred is a double-screw extruder. As the screw for melting, usable here are any known screws, for example, those for nylon or polyolefin, as well as those for mild compression or rapid compression, and single-flight or double-flight screws, to which, however, the present invention is not limited.

### 3-2-1. Polyolefin

Specific examples of the polyolefin include olefin homopolymers such as polyethylene, polypropylene, polybutene-1, poly-4-methylpentene-1, etc.; copolymers of ethylene and α-olefin, such as ethylene-propylene random copolymer, ethylene-propylene block copolymer, ethylene-propylene-poly-butene-1 copolymer, ethylene-cyclic olefin copolymer, etc.; other ethylene copolymers such as ethylene-α,β-unsaturated carboxylic acid copolymer, ethylene-α,β-unsaturated carboxylate copolymer, ion-crosslinked, ethylene-α,β-unsaturated carboxylic acid copolymer, ethylene-vinyl acetate copolymer, partially or wholly-saponified, ethylene-vinyl acetate copolymer, etc.; graft-modified polyolefins produced by graft-modifying these polyolefins with acid anhydride such as maleic anhydride, etc.

### 3-2-2. Polyester

The polyester includes those formed of one or more selected from polycarboxylic acids including dicarboxylic acids and their ester-forming derivatives, and one or more selected from polyalcohols including glycol; those comprising a hydroxycarboxylic acid and its ester-forming derivative; and those comprising a cyclic ester.

The dicarboxylic acid includes saturated aliphatic dicarboxylic acids such as typically oxalic acid, malonic acid, succinic acid, glutaric acid, adipic acid, pimelic acid, suberic acid, azelaic acid, sebacic acid, decanedicarboxylic acid, dodecanedicarboxylic acid, tetradecanedicarboxylic acid, hexadecanedicarboxylic acid, 3-cyclobutanedicarboxylic acid, 1,3-cyclopentanedicarboxylic acid, 1,2-cyclohexanedicarboxylic acid, 1,3-cyclohexanedicarboxylic acid, 1,4-cyclohexanedicarboxylic acid, 2,5-norbornanedicarboxylic acid, dimer acid, and their ester-forming derivatives; unsaturated aliphatic dicarboxylic acids such as typically fumaric acid, maleic acid, itaconic acid, and their ester-forming derivatives; aromatic dicarboxylic acids such as orthophthalic acid, isophthalic acid, terephthalic acid, diphenic acid, 1,3-naphthalenedicarboxylic acid, 1,4-naphthalenedicarboxylic acid, 1,5-naphthalenedicarboxylic acid, 2,6-naphthalenedicarboxylic acid, 2,7-naphthalenedicarboxylic acid, 4,4′-biphenyldicarboxylic acid, 4,4′-biphenylsulfonedicarboxylic acid, 4,4′-biphenyletherdicarboxylic acid, 1,2-bis(phenoxy)ethane-p,p′-dicarboxylic acid, pamoic acid, anthracenedicarboxylic acid, and their ester-forming derivatives; metal sulfonate group-containing aromatic dicarboxylic acids such as typically 5-sodium-sulfoisophthalic acid, 2-sodium-sulfoterephthalic acid, 5-lithium-sulfoisophthalic acid, 2-lithium-sulfoterephthalic acid, 5-potassium-sulfoisophthalic acid, 2-potassium-sulfoterephthalic acid, and their lower alkyl ester derivatives, etc.

Of the above-mentioned dicarboxylic acids, especially preferred is use of terephthalic acid, isophthalic acid or naphthalenedicarboxylic acid, from the viewpoint of the physical properties of the polyester to be obtained, and if desired, any other dicarboxylic acid may be copolymerized with the polyester.

The other polycarboxylic acids than these dicarboxylic acids include ethanetricarboxylic acid, propanetricarboxylic acid, butanetetracarboxylic acid, pyromellitic acid, trimellitic acid, trimesic acid, 3,4,3′,4′-biphenyltetracarboxylic acid, and their ester-forming derivatives, etc.

The glycol includes aliphatic glycols such as ethylene glycol, 1,2-propylene glycol, 1,3-propylene glycol, diethylene glycol, triethylene glycol, 1,2-butylene glycol, 1,3-butylene glycol, 2,3-butylene glycol, 1,4-butylene glycol, 1,5-pentanediol, neopentyl glycol, 1,6-hexanediol, 1,2-cyclohexanediol, 1,3-cyclohexanediol, 1,4-cyclohexanediol, 1,2-cyclohexanedimethanol, 1,3-cyclohexanedimethanol, 1,4-cyclohexanedimethanol, 1,4-cyclohexanediethanol, 1,10-decamethylene glycol, 1,12-dodecanediol, polyethylene glycol, polytrimethylene glycol, polytetramethylene glycol, etc.; aromatic glycols such as hydroquinone, 4,4′-dihydrobisphenol, 1,4-bis(β-hydroxyethoxy)benzene, 1,4-bis(β-hydroxyethoxyphenyl) sulfone, bis(p-hydroxyphenyl)ether, bis(p-hydroxyphenyl) sulfone, bis(p-hydroxyphenyl)methane, 1,2-bis(p-hydroxyphenyl)ethane, bisphenol A, bisphenol C, 2,5-naphthalenediol, glycols prepared by adding ethylene oxide to these glycols, etc.

Of the above-mentioned glycols, especially preferred is use of ethylene glycol, 1,3-propylene glycol, 1,4-butylene glycol, or 1,4-cyclohexanedimethanol as the main ingredient. Other polyalcohols than these glycols include trimethylolmethane, trimethylolethane, trimethylolpropane, pentaerythritol, glycerol, hexanetriol, etc. The hydroxycarboxylic acid includes lactic acid, citric acid, malic acid, tartaric acid, hydroxyacetic acid, 3-hydroxyacetic acid, p-hydroxybenzoic acid, p-(2-hydroxyethoxy)benzoic acid, 4-hydroxycyclohexanecarboxylic acid, and their ester-forming derivatives.

The cyclic ester includes ε-caprolactone, β-propiolactone, β-methyl-β-propiolactone, δ-valerolactone, glycolide, lactide, etc.

The ester-forming derivatives of those polycarboxylic acids and hydroxycarboxylic acids include alkyl esters, acid chlorides, acid anhydrides and the like thereof.

The polyester for use in the present invention is preferably a polyester in which the main acid component is a terephthalic acid or its ester-forming derivative or a naphthalenedicarboxylic acid or its ester-forming derivative and the main glycol component is an alkylene glycol.

The polyester in which the main acid component is a terephthalic acid or its ester-forming derivative is preferably a polyester in which a terephthalic acid or its ester-forming derivative accounts for at least 70 mol % in total of the entire acid component therein, more preferably at least 80 mol %, even more preferably at least 90 mol %. Similarly, the polyester in which the main acid component is a naphthalenedicarboxylic acid or its ester-forming derivative is preferably a polyester in which a naphthalenedicarboxylic acid or its ester-forming derivative accounts for at least 70 mol % in total of the entire acid component therein, more preferably at least 80 mol %, even more preferably at least 90 mol %.

The naphthalenedicarboxylic acid or its ester-forming derivative usable in the present invention is preferably 1,3-naphthalenedicarboxylic acid, 1,4-naphthalenedicarboxylic acid, 1,5-naphthalenedicarboxylic acid, 2,6-naphthalenedicarboxylic acid, 2,7-naphthalenedicarboxylic acid, as exemplified hereinabove for the above-mentioned dicarboxylic acids, or the ester-forming derivative thereof.

The polyester in which the main glycol component is an alkylene glycol is preferably a polyester in which an alkylene glycol accounts for at least 70 mol % in total of the entire glycol component, more preferably at least 80 mol %, even more preferably at least 90 mol %. The alkylene glycol as referred to herein may contain a substituent or an alicyclic structure in the molecular chain thereof.

The other copolymerization component than the above-mentioned terephthalic acid/ethylene glycol is preferably at least one selected from a group consisting of isophthalic acid, 2,6-naphthalenedicarboxylic acid, diethylene glycol, neopentyl glycol, 1,4-cyclohexanedimethanol, 1,2-propanediol, 1,3-propanediol and 2-methyl-1,3-propanediol, from the viewpoint of satisfying both transparency and formability, and is more preferably at least one selected from a group consisting of isophthalic acid, diethylene glycol, neopentyl glycol, 1,4-cyclohexanedimethanol.

One preferred example of the polyester for use in the present invention is a polyester in which the main recurring unit is formed of ethylene terephthalate, and more preferred is a linear polyester containing an ethylene terephthalate unit in an amount of at least 70 mol %, even more preferred is a linear polyester containing an ethylene terephthalate unit in an amount of at least 80 mol %, and still more preferred is a linear polyester containing an ethylene terephthalate unit in an amount of at least 90 mol %.

Another preferred example of the polyester for use in the present invention is a polyester in which the main recurring unit is formed of ethylene 2,6-naphthalate, and more preferred is a linear polyester containing an ethylene 2,6-naphthalate unit in an amount of at least 70 mol %, even more preferred is a linear polyester containing an ethylene 2,6-naphthalate unit in an amount of at least 80 mol %, and still more preferred is a linear polyester containing an ethylene 2,6-naphthalate unit in an amount of at least 90 mol %.

Still another preferred example of the polyester for use in the present invention is a linear polyester containing a propylene terephthalate unit in an amount of at least 70 mol %, a linear polyester containing a propylene naphthalate unit in an amount of at least 70 mol %, a linear polyester containing a 1,4-cyclohexanedimethylene terephthalate unit in an amount of at least 70 mol %, a linear polyester containing a butylene naphthalate unit in an amount of at least 70 mol %, or a linear polyester containing a butylene terephthalate unit in an amount of at least 70 mol %.

As the composition of the entire polyester, preferred is a combination of terephthalic acid/isophthalic acid//ethylene glycol, a combination of terephthalic acid//ethylene glycol/1,4-cyclohexanedimethanol, or a combination of terephthalic acid//ethylene glycol/neopentylglycol, from the viewpoint of satisfying both transparency and formability. Needless-to-say, naturally, the polyester may contain a small amount (at most 5 mol %) of diethylene glycol to be formed through dimerization of ethylene glycol during esterification (interesterification) and polycondensation.

Still another preferred example of the polyester for use in the present invention is a polyglycolic acid to be obtained through polycondensation of glycolic acid or methyl glycolate or through ring-opening polycondensation of a glycolide. The polyglycolic acid may be copolymerized with any other component such as lactide, etc.

### 3-2-3. Polyamide

The polyamide for use in the present invention includes a polyamide comprising, as the main constituent unit therein, a unit derived from a lactam or an aminocarboxylic acid, an aliphatic polyamide comprising, as the main constituent unit therein, a unit derived from an aliphatic diamine and an aliphatic dicarboxylic acid, a partially aromatic polyamide comprising, as the main constituent unit therein, a unit derived from an aliphatic diamine and an aromatic dicarboxylic acid, a partially aromatic polyamide comprising, as the main constituent unit therein, a unit derived from an aromatic diamine and an aliphatic dicarboxylic acid, etc., and if desired, the polyamide may be copolymerized with any other monomer unit than the main constituent unit therein.

The lactam or the aminocarboxylic acid for use herein includes lactams such as ε-caprolactam, laurolactam, etc.; aminocarboxylic acids such as aminocaproic acid, aminoundecanoic acid, etc.; aromatic aminocarboxylic acids such as para-aminomethylbenzoic acid, etc.

The aliphatic diamine for use herein includes aliphatic diamines having from 2 to 12 carbon atoms, and their functional derivatives. This may also be an alicyclic diamine. The aliphatic diamine may be a linear chain-like aliphatic diamine or a branched chain-like aliphatic diamine. Specific examples of the linear chain-like aliphatic diamine include aliphatic diamines such as ethylene diamine, 1-methylethylenediamine, 1,3-propylenediamine, tetramethylenediamine, pentamethylenediamine, hexamethylenediamine, heptamethylenediamine, octamethylenediamine, nonamethylenediamine, decamethylenediamine, undecamethylenediamine, dodecamethylenediamine, etc. Specific examples of the alicyclic diamine include cyclohexanediamine, 1,3-bis(aminomethyl)cyclohexane, 1,4-bis(aminomethyl)cyclohexane, etc.

The aliphatic dicarboxylic acid is preferably a linear aliphatic dicarboxylic acid or an alicyclic dicarboxylic acid, more preferably a linear aliphatic dicarboxylic acid having an alkylene group with from 4 to 12 carbon atoms. Examples of the linear aliphatic dicarboxylic acid of the type include adipic acid, sebacic acid, malonic acid, succinic acid, glutaric acid, pimelic acid, suberic acid, azelaic acid, undecanoic acid, undecanedioic acid, dodecanedioic acid, dimer acid and their functional derivatives. The alicyclic dicarboxylic acid includes alicyclic dicarboxylic acids such as 1,4-cyclohexanedicarboxylic acid, hexahydroterephthalic acid, hexahydroisophthalic acid, etc.

The aromatic diamine includes metaxylylenediamine, paraxylylenediamine, para-bis(2-aminoethyl)benzene, etc.

The aromatic dicarboxylic acid includes terephthalic acid, isophthalic acid, phthalic acid, 2,6-naphthalenedicarboxylic acid, diphenyl-4,4′-dicarboxylic acid, diphenoxyethanedicarboxylic acid and their functional derivatives, etc.

Concrete polyamides include polyamide 4, polyamide 6, polyamide 10, polyamide 11, polyamide 12, polyamide 4,6, polyamide 6,6, polyamide 6,10, polyamide 6T, polyamide 9T, polyamide 6IT, polymetaxylylenadipamide (polyamide MXD6), isophthalic acid-copolymerized polymetaxylylenadipamide (polyamide MXD6I), polymetaxylylenesebacamide (polyamide MXD10), polymetaxylylenedodecanamide (polyamide MXD 12), poly-1,3-bisaminocyclohexaneadipamide (polyamide BAC6), polyparaxylylenesebacamide (polyamide PXD10), etc. More preferred polyamides are polyamide 6, polyamide MXD6, polyamide MXD6I.

As the copolymerization component of the polyamide, usable is a polyether having at least one terminal amino group or at least one terminal carboxyl group and having a number-average molecular weight of from 2,000 to 20,000, or an organic carboxylic acid salt of the terminal amino group-having polyether, or an amine salt of the terminal carboxyl group-having polyether. Concrete examples of the component include bis(aminopropyl)poly(ethylene oxide) (polyethylene glycol having a number-average molecular weight of from 2,000 to 20,000).

The partially aromatic polyamide may contain a constituent unit derived from a tribasic or more polycarboxylic acid such as trimellitic acid, pyromellitic acid or the like, within a range within which its structure is substantially linear.

The polyamide may be produced basically according to a conventional known, melt polycondensation method in the presence of water or melt polycondensation method in the absence of water, or according to a solid-phase polymerization method of further processing the polyamide obtained according to the previous melt polycondensation method. The melt polycondensation reaction may be attained in one stage or may be attained in multiple stages. The apparatus for the method may be a batch reaction apparatus, or may be a continuous reaction apparatus. The melt polycondensation step and the solid-phase polymerization step may be attained continuously, or may be attained intermittently as separated.

### 3-2-4. Polyvinyl Alcohol

Specific examples of the polyvinyl alcohol include polyvinyl alcohol, ethylene-vinyl alcohol copolymer and their partially or wholly saponified products, etc. Further, their modified products may also be usable here.

### 3-2-5. Vegetable-Derived Resin

Not specifically defined, concrete examples of the vegetable-derived resin include various aliphatic polyester-type biodegradable resins starting from any others than petroleum, though partly overlapping with the above-mentioned resins. The aliphatic polyester-type biodegradable resins include, for example, poly(α-hydroxy acids) such as polyglycolic acid (PGA), polylactic acid (PLA), etc.; polyalkylenes alkanoates such as polybutylene succinate (PBS), polyethylene succinate (PES), etc.

### 3-3. Metal

In case where the polyesteramide compound of the present invention is required to have additional oxygen absorption performance in addition to the oxygen absorbing effect thereof, at least one metal atom selected from Group VIII metals of the Periodic Table such as iron, cobalt, nickel, etc.; Group I metals such as copper, silver, etc.; Group IV metals such as tin, titanium, zirconium, etc.; Group V metals such as vanadium, etc.; Group VI metals such as chromium, etc.; Group VII metals such as manganese, etc., may be added thereto in the form of a compound or a metal complex thereof, before the start of polycondensation reaction or during the reaction or during extrusion. Of those metal atoms, preferred are Group VIII metal atoms from the viewpoint of the oxygen absorption performance, and more preferred is a cobalt atom.

In the present invention, when the metal atom is added to and mixed with the esteramide compound, preferably, a compound containing the metal atom (hereinafter this may be referred to as a metal catalyst compound) is used. The metal catalyst compound may be used here in the form of a low-valence inorganic acid salt, organic acid salt or complex salt of the metal atom.

The inorganic acid salt includes halides such as chlorides, bromides, etc.; sulfur oxyacid salts such as sulfate salts, etc.; nitrogen oxyacid salts such as nitrate salts, etc.; phosphorus oxyacid salts such as phosphate salts, etc.; silicate salts, etc. On the other hand, the organic acid salt includes carboxylate salts, sulfonate salts, phosphonate salts, etc. Carboxylate salts are preferred for the object of the present invention, and their specific examples include transition metal salts of acetic acid, propionic acid, isopropionic acid, butanoic acid, isobutanoic acid, pentanoic acid, isopentanoic acid, hexanoic acid, heptanoic acid, isoheptanoic acid, octanoic acid, 2-ethylhexanoic acid, nonanoic acid, 3,5,5-trimethylhexanoic acid, decanoic acid, neodecanoic acid, undecanoic acid, lauric acid, myristic acid, palmitic acid, margaric acid, stearic acid, arachic acid, linderic acid, tsuzuic acid, petroselinic acid, oleic acid, linolic acid, linolenic acid; arachidic acid, formic acid, oxalic acid, sulfamic acid, naphthenic acid, etc.

Also usable here are metal complexes with a β-diketone or β-keto acid ester, etc. The β-diketone or the β-keto acid ester for use herein includes, for example, acetylacetone, ethyl acetacetate, 1,3-cyclohexadione, methylenebis-1,3-cyclohexadione, 2-benzyl-1,3-cyclohexadione, acetyltetralone, palmitotetralone, stearoyltetralone, benzoyltetralone, 2-acetylcyclohexanone, 2-benzoylcyclohexanone, 2-acetyl-1,3-cyclohexanedione, benzoyl-p-chlorobenzoylmethane, bis(4-methylbenzoyl)methane, bis(2-hydroxybenzoyl)methane, benzoylacetone, tribenzoylmethane, diacetylbenzoylmethane, stearoylbenzoylmethane, palmitobenzoylmethane, lauroylbenzoylmethane, dibenzoylmethane, bis(4-chlorobenzoyl)methane, bis(methylene-3,4-dioxybenzoyl)methane, benzoylacetylphenylmethane, stearoyl(4-methoxybenzoypmethane, butanoylacetone, distearoylmethane, acetylacetone, stearoylacetone, bis(cyclohexanoyl)-methane, dipivaloylmethane, etc.

Of those, preferred are carboxylate salts, halides and acetylacetonate complexes containing the above-mentioned metal atom, as capable of enhancing the oxygen absorption performance of the composition.

One or more of the above-mentioned metal catalyst compounds may be added to the compound. Especially preferred are those containing cobalt as the metal atom as excellent in their ability to enhance the oxygen absorption performance of the composition. Even more preferred is cobalt(II) stearate or cobalt(II) acetate as excellent in the handleability thereof in melt mixing in the form of a solid or a powder of the compound.

The concentration of the metal atom to be added to the polyesteramide compound is not specifically defined. Preferably, the concentration is from 1 to 1,000 ppm relative to 100 parts by mass of the polyesteramide compound, more preferably from 1 to 700 ppm. When the amount added of the metal atom is at least 1 ppm, then the polyesteramide compound of the present invention can sufficiently express the oxygen absorption function thereof in addition to the oxygen absorption effect thereof, therefore realizing the effect of enhancing the oxygen barrier property of packaging materials of the composition. The method of adding the metal catalyst compound to the polyesteramide compound is not specifically defined, and the compound may be added thereto in any desired method.

### 3-4. Oxidizing Organic Compound

The polyesteramide composition of the present invention may further contain an oxidizing organic compound.

The oxidizing organic compound is an organic compound which is automatically oxidized in an atmosphere where oxygen exists, in the presence of at least one of catalyst, heat, light, moisture or the like, and is preferably one having an active carbon atom that enables easy drawing of hydrogen. Specific examples of the active carbon atom include a carbon atom adjacent to a carbon-carbon double bond, a tertiary carbon atom to which a carbon side chain bonds, and those containing an active methylene group.

For example, vitamin C and vitamin E are examples of the oxidizing organic compound. In addition, polymers having an easily-oxidizable tertiary hydrogen in the molecule, such as polypropylene or the like, compounds having a carbon-carbon double bond in the molecule such as butadiene, isoprene, cyclohexanone or the like, as well as polymers formed of such compounds or comprising them are also examples of the oxidizing organic compound. Among these, preferred are compounds and polymers having a carbon-carbon double bond from the viewpoint of the oxygen absorption performance and the workability thereof; and more preferred are compounds having a carbon-carbon double bond and having from 4 to 20 carbon atoms, as well as oligomers or polymers containing a unit derived from such compounds.

The compound having a carbon-carbon double bond and having from 4 to 20 carbon atoms includes, for example, conjugated dienes such as butadiene, isoprene, etc.; linear non-conjugated dienes such as 1,4-hexadiene, 3-methyl-1,4-hexadiene, 4-methyl-1,4-hexadiene, 5-methyl-1,4-hexadiene, 4,5-dimethyl-1,4-hexadiene, 7-methyl-1,6-octadiene, etc.; cyclic non-conjugated dienes such as methyltetrahydroindene, 5-ethylidene-2-norbornene, 5-methylene-2-norbornene, 5-isopropylidene-2-norbornene, 5-vinylidene-2-norbornene, 6-chloromethyl-5-isopropenyl-2-norbornene, dicyclopentadiene, etc.; trienes such as 2,3-diisopropylidene-5-norbornene, 2-ethylidene-3-isopropylidene-5-norbornene, 2-propenyl-2,2-norbornadiene, etc.; chloroprene, etc.

These compounds may be incorporated in the composition, alone or in the form of a combination of two or more of them or in the form of a combination thereof with any other monomer, as homopolymers, random copolymers, block copolymers, etc.

The monomer to be used for the combination includes α-olefins having from 2 to 20 carbon atoms, such as ethylene, propylene, 1-butene, 4-methyl-1-pentene, 1-hexene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-nonadecene, 1-eicosene, 9-methyl-1-decene, 11-methyl-1-dodecene, 12-ethyl-1-tetradecene. In addition, also usable here are other monomers such as styrene, vinyltoluene, acrylonitrile, methacrylonitrile, vinyl acetate, methyl methacrylate, ethyl acrylate, etc.

As the oligomer or polymer containing a unit derived from the compound having a carbon-carbon double bond and having from 4 to 20 carbon atoms, concretely mentioned are polybutadiene (BR), polyisoprene (IR), butyl rubber (TM), natural rubber, nitrile-butadiene rubber (NBR), styrene-butadiene rubber (SBR), chloroprene rubber (CR), ethylene-propylene-diene rubber (EPDM), etc.; however, the present invention is not limited to these examples. In the polymer, the carbon-carbon double bond is not specifically defined. The bond may exist in the main chain of the polymer in the form of a vinylene group, or may exist in the side chain thereof in the form of a vinyl group.

Preferably, the oligomer or polymer containing a unit derived from the above-mentioned compound having a carbon-carbon double bond contains, as introduced thereinto, a carboxylic acid group, a carboxylic acid anhydride group or a hydroxyl group in the molecule thereof, or is blended with an oligomer or polymer modified with the functional group. The monomer to be used for introducing the functional group includes ethylenic unsaturated monomers having a functional group such as a carboxylic acid group, a carboxylic acid anhydride group, a carboxylic acid salt group, a carboxylate ester group, a carboxylic acid amide group, a carbonyl group, a hydroxyl group or the like.

As the monomer, preferably used are unsaturated carboxylic acids or their derivatives. Concretely, there are mentioned α,β-unsaturated carboxylic acids such as acrylic acid, methacrylic acid, maleic acid, fumaric acid, itaconic acid, citraconic acid, tetrahydrophthalic acid, etc.; unsaturated carboxylic acids such as bicycle[2,2,1]hept-2-ene-5,6-dicarboxylic acid, etc.; α,β-unsaturated carboxylic acid anhydrides such as maleic anhydride, itaconic anhydride, citraconic anhydride, tetrahydrophthalic anhydride, etc.; and unsaturated carboxylic acid anhydrides such as bicycle[2,2,1]hept-2-ene-5,6-dicarboxylic anhydride, etc.

Acid-modified derivatives of the oligomer or polymer that contains a unit derived from the compound having a carbon-carbon double bond may be produced by graft-copolymerizing the oligomer or polymer with an unsaturated carboxylic acid or its derivative in any per-se known method, or may also be produced through random copolymerization of the above-mentioned carbon-carbon double bond-having compound and an unsaturated carboxylic acid or its derivative.

Regarding the content of the oxidizing organic compound in the polyesteramide composition, the preferred content thereof is from 0.01 to 10% by mass in the composition from the viewpoint of the oxygen absorption performance and the transparency of the composition, more preferably from 0.1 to 8% by mass, even more preferably from 0.5 to 5% by mass.

### 4. Use of Polyesteramide Compound and Polyesteramide Composition

The polyesteramide compound and the polyesteramide composition of the present invention are usable for various applications that require oxygen barrier property and oxygen absorption performance. For example, the polyesteramide compound of the present invention can be filled in small pouches by itself therein and can be used as an oxygen absorbent.

Typical application examples of the polyesteramide compound and the polyesteramide composition of the present invention include shapes of packaging materials, packaging containers, etc., to which, however, the present invention is not limited. The polyesteramide compound or the polyesteramide composition of the present invention may be worked to give a shape that comprising it as at least a part of the shape for use in the present invention. For example, the polyesteramide compound or the polyesteramide composition of the present invention may be used as at least a part of a filmy or sheet-like packaging material. In addition, it may be used as at least a part of packaging containers such as bottles, trays, cups, tubes, as well as various types of pouches such as flat pouches, standing pouches, etc. The structure of the shape of the packaging material or the packaging container may be a single-layer structure comprising a layer of the polyesteramide compound or the polyesteramide composition of the present invention, or may be a multilayer structure comprising a combination of that layer and a layer of any other thermoplastic resin. Not specifically defined, the thickness of the layer of the polyesteramide compound or the polyesteramide composition of the present invention is preferably at least 1 μm.

The method for producing the shapes of packaging materials and packaging containers is not specifically defined, for which any method is employable. For example, for forming a filmy or sheet-like packaging material, or a tubular packaging material, the polyesteramide compound or the polyesteramide composition of the present invention that has been melted through a T-die, a circular die or the like may be extruded out through the accompanying extruder. The filmy shape obtained according to the above-mentioned method may be stretched to give a stretched film. The bottle-shaped packaging containers may be produced by injecting a molten polyesteramide resin or resin composition into a mold from an injection-molding machine to prepare a preform, followed by blow-stretching it by heating up to the stretching temperature thereof.

Containers such as trays, cups and the like can be produced according to a method of injecting a molten polyesteramide compound or polyesteramide composition into a mold from an injection-molding machine followed by molding it therein, or according to a method of forming a sheet-like packaging material into shapes in a mode of vacuum forming, pressure forming or the like. The packaging materials and the packaging containers can be produced according to various methods, not limited to the above-mentioned production methods.

The packaging materials and the packaging containers obtained by the use of the polyesteramide compound and the polyesteramide composition of the present invention are suitable for housing and storing various goods. For example, they can be used for housing and storing various goods such as drinks, seasonings, cereals, liquid and solid processed foods that are needed to be filled in a germ-free condition or to be thermally sterilized, chemicals, liquid livingware, drugs, semiconductor integrated circuits, electronic devices, etc.

### EXAMPLES

The present invention is described in more detail with reference to the following Examples; however, the present invention is not limited to these Examples.

In the following Examples, polyglycolic acid is referred to as “PGA”, and L-polylactic acid is as “PLLA”.

The polyesteramide compounds and the polyester compounds obtained in Examples and Comparative Examples were analyzed for the constituent composition, the limiting viscosity, the glass transition temperature and the melting point thereof; according to the methods mentioned below. In addition, they were tested for the oxygen absorption thereof according to the method mentioned below.

### (1) Constituent Composition

Using a ¹H-NMR apparatus (400 MHz; JEOL's trade name, JNM-AL400; operation mode, NON (¹H)), the copolymer was quantitatively analyzed for the constituent composition thereof. Concretely, using trifluoroacetic acid-d as a solvent, a solution of 5% by mass of each the polyesteramide compound and polyester compound was prepared and analyzed through ¹H-NMR.

### (2) Limiting Viscosity

0.5 g of the polyesteramide compound or the polyester compound was dissolved under heat in 120 g of a mixed solvent of phenol/1,1,2,2-tetrachloroethane (ratio by mass, 6/4), filtered and cooled to 25° C. to prepare a test sample. Using a capillary automatic viscometer (Shibayama Scientific's trade name, SS-300-L1), the sample was analyzed at 25° C.

### (3) Glass Transition Temperature and Melting Point

Using a differential scanning calorimeter (Shimadzu's trade name, DSC-60), the sample was analyzed through DSC (differential scanning calorimetry) in a nitrogen current atmosphere at a heating rate of 10° C./min, thereby determining the glass transition temperature (Tg) and the melting point (Tm) thereof. For reference, the melting point of PGA and PLLA not copolymerized with any other component was 221° C. and 170° C., respectively.

### (4) Oxygen Absorption

2 g of a ground sample was put into a three-side sealed bag of an aluminium foil laminate film having a size of 25 cm×18 cm, along with cotton infiltrated with 10 ml of water therein, and sealed up so that the in-bag air amount could be 400 ml. The humidity inside the bag was made to be 100% RH (relative humidity). After thus stored at 40° C. for 28 days, the oxygen concentration inside the bag was measured with an oxygen concentration gauge (Toray Engineering's trade name, LC-700F). From the oxygen concentration, the oxygen absorption (cc/g) of the sample was calculated. The sample having a higher value of oxygen absorption is more excellent in oxygen absorption performance and is better.

### Example 1

### Polymerization for Polyesteramide Compound

120 g (1.03 mol) of glycolide, 9.21 g (0.103 mol) of DL-alanine (by Musashino Chemical Laboratory, Ltd.), 6 mg (5 ppm relative to glycolide) of tin tetrachloride and 60 mg (0.05% by mass relative to glycolide) of lauryl alcohol were put into a 500-ml stainless flask, fully purged with argon, and with stirring with a stirring blade, polymerized at 200° C. for 3 hours under a reduced pressure of 5 mmHg. After the polymerization, this was cooled and the polymer was taken out, ground and washed with acetone. Subsequently, this was dried in vacuum at 150° C. for 5 hours to give a DL-alanine-copolymerized polyglycolic acid (DL-alanine-copolymerized PGA) (polyesteramide compound 1).

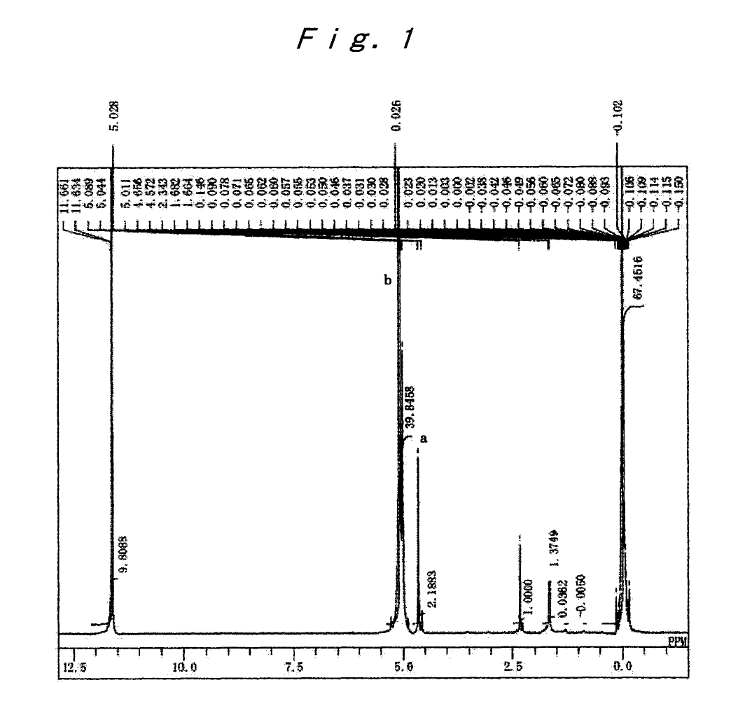

FIG. 1 shows a ¹H-NMR chart of the obtained polyesteramide compound 1.

The absorption peak at around 4.6 ppm in FIG. 1 is an absorption peak a derived from the hydrogen of the methine group of DL-alanine, and FIG. 1 shows the integrated intensity of the absorption peak a. The absorption peak at around 5 ppm is an absorption peak b derived from the hydrogen of the methylene group of polyglycolic acid; and FIG. 1 shows the integrated intensity of the absorption peak b.

The amount of the DL-alanine unit in the polyesteramide compound can be calculated according to the following formula.

$$Amount of DL \text{-} Alanine Unit in Polyesteramide Compound ( mol \% ) = \frac{a}{a + ( b / 2 )} \times 100$$

The above calculation identifies the existence of the DL-alanine unit in an amount of about 10 mol % in the polyesteramide compound 1.

Also in the following Examples and Comparative Examples, the prepared polyesteramide compounds and the polyester compounds were analyzed and quantified for the constituent thereof in the same manner as above.

### Example 2

An L-alanine-copolymerized PGA (polyesteramide compound 2) was produced according to the same method as in Example 1 except that the α-amino acid was changed to L-alanine (by Sinogel Amino Acid Co., Ltd.).

### Example 3

A D-alanine-copolymerized PGA (polyesteramide compound 3) was produced according to the same method as in Example 1 except that the α-amino acid was changed to D-alanine (by Musashino Chemical Laboratory, Ltd.).

### Example 4

A DL-2-aminobutyric acid-copolymerized PGA (polyesteramide compound 4) was produced according to the same method as in Example 1 except that the α-amino acid was changed to DL-2-aminobutyric acid (DL-AABA, purified product by Nippon Finechem, Inc.).

### Example 5

A DL-leucine-copolymerized PGA (polyesteramide compound 5) was produced according to the same method as in Example 1 except that the α-amino acid was changed to DL-leucine (by Ningbo Haishuo bio-Technology).

### Example 6

A DL-phenylalanine-copolymerized PGA (polyesteramide compound 6) was produced according to the same method as in Example 1 except that the α-amino acid was changed to DL-phenylalanine (DL-Phe, by Sinogel Amino Acid Co., Ltd.).

### Example 7

A DL-alanine-copolymerized PGA (polyesteramide compound 7) was produced according to the same method as in Example 1 except that the amount of DL-alanine was so changed that the content thereof in the polyesteramide compound could be 5 mol %.

### Example 8

A DL-alanine-copolymerized PGA (polyesteramide compound 8) was produced according to the same method as in Example 1 except that the amount of DL-alanine was so changed that the content thereof in the polyesteramide compound could be 20 mol %.

### Example 9

A DL-alanine-copolymerized PGA (polyesteramide compound 9) was produced according to the same method as in Example 1 except that the amount of DL-alanine was so changed that the content thereof in the polyesteramide compound could be 40 mol %.

### Example 10

### Polymerization for Polyesteramide Compound

120 g (1.03 mol) of methyl glycolate, 9.21 g (0.103 mol) of DL-alanine (by Musashino Chemical Laboratory, Ltd.), 6 mg (5 ppm relative to methyl glycolate) of stannic chloride and 60 mg (0.05% by mass relative to methyl glycolate) of lauryl alcohol were put into a 500-ml stainless flask, fully purged with argon, and with stirring with a stirring blade, polymerized at 150° C. for 3 hours. After the polymerization, this was cooled and the polymer was taken out, ground and washed with acetone. Subsequently, this was dried in vacuum at 150° C. for 5 hours to give a DL-alanine-copolymerized polyglycolic acid (DL-alanine-copolymerized PGA) (polyesteramide compound 10).

### Example 11

A mixture of 1297 g (14.4 mol as lactic acid monomer) of L-polylactic acid (Cargill-Dow's trade name, polylactic acid 6250D) and 142 g (1.6 mol) of DL-alanine (by Musashino Chemical Laboratory, Ltd.) was heated in a one-liter autoclave with stirring at 220° C. for 1 hour, and then the temperature of the system was elevated up to 240° C. and the pressure of the system was gradually lowered to be 13 Pa after 1.5 hours. Under the condition, the system was polycondensed for 8 hours. After the polymerization, this was cooled and the polymer was taken out, ground and washed with acetone. Subsequently, this was dried in vacuum at 120° C. for 5 hours to give a DL-alanine-copolymerized L-polylactic acid (DL-alanine-copolymerized PLLA) (polyesteramide compound 11).

### Example 12

100 g of the polyesteramide compound 1 obtained in Example 1 and 50 g of liquid paraffin were put into an eggplant flask, and with stirring, this was heated at 190° C. for 1 hour and at 210° C. for 6 hours for solid-phase polymerization to give a DL-alanine-copolymerized PGA (polyesteramide compound 12).

### Example 13

A DL-alanine-copolymerized PGA (polyesteramide compound 13) was produced according to the same method as in Example 1 except that the polymerization time at 200° C. was changed to 1.5 hours.

### Comparative Example 1

### Polymerization for Polyester Compound

98.7 g (8.5 mol) of glycolide, 5 mg (5 ppm relative to glycolide) of tin tetrachloride and 51 mg (0.05% by mass relative to glycolide) of lauryl alcohol were put into a 500-ml stainless flask, fully purged with argon, and with stirring with a stirring blade, polymerized at 200° C. for 3 hours. After the polymerization, this was cooled, and the polymer was taken out, ground and washed with acetone. Subsequently, this was dried in vacuum at 150° C. for 5 hours to give polyglycolic acid (PGA).

### Comparative Example 2

### Polymerization for Polyesteramide Compound

Glycine-copolymerized PGA was produced according to the same method as in Example 1 except that the α-amino acid was changed to glycine having a secondary hydrogen at the a-position (Tokyo Chemical Industry Co., Ltd.).

### Comparative Example 3

2-Aminoisobutyric acid PGA was produced according to the same method as in Example 1 except that the α-amino acid was changed to 2-aminoisobutyric acid not having a hydrogen at the a-position (2-amino-2-methylpropanoic acid, ALB, pure product by Nippon Finechem, Inc.).

### Comparative Example 4

Pellets of L-polylactic acid (Cargill-Dow's trade name, polylactic acid 6250D) were used.

TABLE 1

| | | Amino Acid | Limiting | | | Oxygen Absorption |
|---|---|---|---|---|---|---|
| | | Content | Viscosity | Tg | Tm | Amount (cc/g) |
| | Polyesteramide or Polyester | (mol %) | (dl/g) | (° C.) | (° C.) | 40° C., after 28 days |
| Example 1 | DL-alanine-copolymerized PGA*¹⁾ | 10 | 0.5 | 27 | 199 | 9 |
| Example 2 | L-alanine-copolymerized PGA | 10 | 0.5 | 27 | 198 | 9 |
| Example 3 | D-alanine-copolymerized PGA | 10 | 0.5 | 27 | 198 | 9 |
| Example 4 | DL-AABA*²⁾-copolymerized PGA | 10 | 0.5 | 27 | 198 | 7 |
| Example 5 | DL-leucine-copolymerized PGA | 10 | 0.5 | 26 | 198 | 7 |
| Example 6 | DL-Phe*³⁾-copolymerized PGA | 10 | 0.5 | 28 | 198 | 7 |
| Example 7 | DL-alanine-copolymerized PGA | 5 | 0.6 | 33 | 210 | 4 |
| Example 8 | DL-alanine-copolymerized PGA | 20 | 0.4 | 18 | 178 | 17 |
| Example 9 | DL-alanine-copolymerized PGA | 40 | 0.5 | 5 | — | 34 |
| Example 10 | DL-alanine-copolymerized PGA | 10 | 0.3 | 27 | 200 | 7 |
| Example 11 | DL-alanine-copolymerized PLLA*⁴⁾ | 10 | 0.2 | 57 | 162 | 8 |
| Example 12 | DL-alanine-copolymerized PGA | 10 | 1.1 | 27 | 199 | 8 |
| Example 13 | DL-alanine-copolymerized PGA | 10 | 0.15 | 28 | 198 | 7 |
| Comparative | PGA | 0 | 0.8 | 39 | 221 | 0 |
| Example 1 | | | | | | |
| Comparative | glycine-copolymerized PGA | 10 | 0.5 | 27 | 198 | 0 |
| Example 2 | | | | | | |
| Comparative | AIB*⁵⁾-copolymerized PGA | 10 | 0.5 | 27 | 198 | 0 |
| Example 3 | | | | | | |
| Comparative | PLLA | 0 | — | 57 | 170 | 0 |
| Example 4 | | | | | | |

*¹⁾PGA: polyglycolic acid
*²⁾DL-AABA: DL-2-aminobutyric acid
*³⁾DL-Phe: DL-phenylalanine
*⁴⁾PLLA: L-polylactic acid
*⁵⁾AIB: 2-aminoisobutyric acid

The polyester compound of polyglycolic acid alone or polylactic acid alone did not exhibit oxygen absorption performance (Comparative Example 1 and Comparative Example 4). In addition, the polyesteramide compound copolymerized with an α-amino acid not having a tertiary hydrogen also did not exhibit oxygen absorption performance (Comparative Examples 2 and 3).

As opposed to these, the polyesteramide compound copolymerized with a tertiary hydrogen-having α-amino acid (polyesteramide resin and polyesteramide oligomer) exhibited sufficient oxygen absorption performance even though not using a metal, and in addition, the compound did not generate any offensive odor (Examples 1 to 13).

### INDUSTRIAL APPLICABILITY

The polyesteramide compound and the polyesteramide composition of the present invention are excellent in oxygen absorption performance. Using the polyesteramide compound and the polyesteramide composition of the present invention in packaging materials and packaging containers provides packaging materials and packaging containers which can express sufficient oxygen absorption performance even though not containing a metal, do not generate any offensive odor, and can store the contents therein in a good condition.

1. A polyesteramide compound, comprising from 50 to 99.9 mol % of an ester unit represented by formula (I), and from 0.1 to 50 mol % of a constituent unit represented by formula (II): 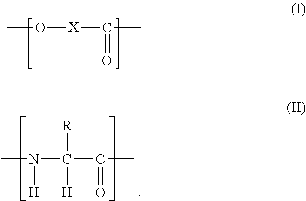
wherein:
X represents an alkylene group; and
R represents a substituted or unsubstituted alkyl group, or a substituted or unsubstituted aryl group.

2. The polyesteramide compound according to claim 1, wherein the ester unit represented by formula (I) is from a cyclic ester, an alkyl hydroxycarboxylate, or both.

3. The polyesteramide compound according to claim 2, wherein the ester unit represented by formula (I) is from a cyclic ester which is glycolide.

4. The polyesteramide compound according to claim 2, wherein the ester unit represented by formula (I) is from an alkyl hydroxycarboxylate which is an alkyl glycolate comprising an alkyl group having from 1 to 4 carbon atoms.

5. The polyesteramide compound according to claim 1, wherein R in the general formula (II) is a substituted or unsubstituted alkyl group having from 1 to 6 carbon atoms, or a substituted or unsubstituted aryl group having from 6 to 10 carbon atoms.

6. The polyesteramide compound according to claim 1, having a limiting viscosity of from 0.4 dl/g to 1.5 dl/g.

7. The polyesteramide compound according to claim 1, having a limiting viscosity of from 0.1 dl/g to less than 0.4 dl/g.

8. A polyesteramide composition, comprising the polyesteramide compound of claim 1.

9. The polyesteramide compound according to claim 2, wherein R in the general formula (II) is a substituted or unsubstituted alkyl group having from 1 to 6 carbon atoms, or a substituted or unsubstituted aryl group having from 6 to 10 carbon atoms.

10. The polyesteramide compound according to claim 2, having a limiting viscosity of from 0.4 dl/g to 1.5 dl/g.

11. The polyesteramide compound according to claim 2, having a limiting viscosity of from 0.1 dl/g to less than 0.4 dl/g.

12. A polyesteramide composition, comprising the polyesteramide compound of claim 2.
